(19) United States
(12) Patent Application Publication
(10) Pub. No.: US 2009/0237000 A1
(43) Pub. Date: Sep. 24, 2009

(54) PDP DRIVING APPARATUS AND PLASMA DISPLAY

(75) Inventor: Manabu Inoue, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/094,332

(22) PCT Filed: Nov. 10, 2006
(86) PCT No.: PCT/JP2006/322453

§ 371 Date: Oct. 7, 2008

Related U.S. Application Data
(63) Continuation-in-part of application No. 11/283,692, filed on Nov. 22, 2005, now abandoned.

(51) Int. Cl. H05B 41/36

(52) U.S. Cl. 315/291

(57) ABSTRACT

A PDP driving apparatus drives a plasma display panel (PDP) having sustain electrodes, scan electrodes, and address electrodes. The PDP driving apparatus includes a high side switch element and a low side switch element, those electrically coupled in series. A specific pulse voltage is applied from a junction point of the high side switch element and the low side switch element to at least sustain electrodes, scan electrodes, or address electrodes of the plasma display panel. At least one of the high side switch element and the low side switch element is a bidirectional switch element.

### TECHNICAL FIELD

The invention relates to a driving apparatus of plasma display panel.

### BACKGROUND ART

Plasma display is a display device making use of light emitting phenomenon by gas discharge. The display portion of the plasma display, that is, a plasma display panel (PDP) is more advantageous than other display devices in the aspect of large screen, thin panel, and wide viewing angle. PDP is roughly classified into DC type operated by direct-current pulses, and AC type operated by alternating-current pulses. The AC type PDP is particularly high in luminance, and simple in structure. Therefore, the AC type PDP is suited to mass production and finer pixel size, and is used in a wide range.

An AC type PDP has, for example, a three-electrode surface discharge structure (see, for example, JP-A-2005-70787). In this structure, address electrodes are disposed on a back surface of PDP in longitudinal direction of the panel, and sustain electrodes and scan electrodes are disposed on a front surface of the PDP alternately in lateral direction of the panel. The address electrode and scan electrode can be generally controlled for the potential individually one by one.

At the intersection of a pair of mutually adjacent sustain electrode and scan electrode and the address electrode, a discharge cell is formed. On the surface of the discharge cell, a layer made of dielectric (dielectric layer), a layer for protecting electrode and dielectric layer (protective layer), and a layer including phosphor (phosphor layer) are provided. The inside of the discharge cell is filled with gas. When discharge occurs in the discharge cell by application of a pulse voltage to the sustain electrode, scan electrode and address electrode, molecules of the gas are ionized to emit ultraviolet rays. The ultraviolet rays excite the phosphor on the discharge cell surface to generate fluorescence. As a result, the discharge cell emits light.

A PDP driving apparatus generally controls potentials of sustain electrode, scan electrode and address electrode of the PDP according to ADS (address display-period separation) method. The ADS method is one of sub-field methods. In the sub-field method, one field of image is divided into plural sub-fields. A sub-field includes a reset period, an address period, and a sustain period. In the ADS method, in particular, these three periods are set commonly in all discharge cells of the PDP (see, for example, JP2005-70787, A).

In the reset period, a reset pulse voltage is applied between the sustain electrode and scan electrode. As a result, wall charge is made uniform in all discharge cells.

In the address period, a scan pulse voltage is sequentially applied to the scan electrode, and a signal pulse voltage is applied to some of the address electrodes. Herein, the address electrodes to which the signal pulse voltage is applied are selected on the basis of a video signal entered from outside. When a scan pulse voltage is applied to one scan electrode and signal pulse voltage is applied to one address electrode, discharge occurs in the discharge cell positioned at the intersection of such scan electrode and address electrode. By this discharge, the wall charge is accumulated on the discharge cell surface.

In the sustain period, a sustain pulse voltage is applied to all pairs of sustain electrode and scan electrode simultaneously and periodically. At this time, in the discharge cell in which the wall charge is accumulated in address period, discharge by gas continues and luminance occurs. Duration of sustain period varies in each sub-field, and the light emitting time per field of discharge cell, that is, the luminance of discharge cell is adjusted by selection of sub-field to be emitted.

FIG. 22 shows a structure of a conventional PDP driving apparatus. In particular, the scan electrode driving section and PDP are shown in FIG. 22. The scan electrode driving section 110 includes a scan pulse generating section 111, a reset pulse generating section 112, and a sustain pulse generating section 113. The sustain pulse generating section 113 includes a high side sustain switch element Q7Y and a low side sustain switch element Q8Y connected in series, and controls, through these sustain switch elements Q7Y and Q8Y, a voltage between the sustain electrode X and scan electrode Y by sustain voltage source Vs or ground potential. The PDP 20 is equivalently expressed by a floating capacity Cp (hereinafter called “PDP panel capacity”) between the sustain electrode X and scan electrode Y, and a path of current flowing in the PDP 20 on discharge in the discharge cell is omitted. In FIG. 22, a sustain electrode driving section connected to the sustain electrodes X is omitted, and the sustain electrodes X are shown as in grounded state in the diagram.

In order to make uniform the wall charge in all discharge cells in the PDP during reset period, the upper limit of reset pulse voltage must be sufficiently higher. To cause address discharge in the address period, the lower limit of the scan pulse voltage must be sufficiently lower. Therefore, the upper limit of reset pulse voltage is generally set higher than the upper limit of the sustain pulse voltage. The lower limit of the scan pulse voltage is generally set lower than the lower limit of the sustain pulse voltage. Therefore, to prevent the reset pulse voltage from being clamped by the upper limit of the sustain pulse voltage, in the reset period, the sustain voltage source of the sustain pulse generating section must be separated from the reset pulse generating section. To prevent the scan pulse voltage from being clamped by the lower limit of the sustain pulse voltage, in the address period, the sustain voltage source of the sustain pulse generating section must be separated from the scan pulse generating section.

In the conventional PDP driving apparatus, separate switch elements QS1 and QS2 are installed between the sustain voltage source Vs and reset pulse generating section 112. In the example in FIG. 22, separate switch elements QS1 and QS2 are inserted.

In the sustain period, the separate switch elements QS1 and QS2 are turned on, and by switching of sustain switch elements Q7Y and Q8Y of the sustain pulse generating section 113, positive or negative potential of the sustain voltage source Vs are supplied from an output terminal JY2 of the sustain pulse generating section 113.

In the reset period, the separate switch elements QS1 and QS2 are turned off, and the reset pulse generating section is separated from the sustain voltage source Vs.

Thus, the reset pulse voltage is not clamped by the upper limit or lower limit of the sustain pulse voltage, but ascends to a specified upper limit, or descends to a specified lower limit. In the reset period, therefore, a sufficient voltage for making the wall charge uniform is applied to all discharge cells of the PDP.

However, in the separate switch elements QS1 and QS2, during the sustain period, a current flows that caused by application of a sustain pulse voltage (a current by discharge in discharge cells of the PDP). This current is generally larger than the current due to application of other pulse voltage, and it is hence important to lower the conduction loss in the separate switch elements in order to save power consumption in the PDP driving apparatus. In particular, the current capacity of separate switch elements must be set larger. Therefore, a multiplicity of separate switch elements are connected in parallel, and the mounting area of separate switch elements is increased. As a result, it has been difficult to save power consumption and curtail the number of parts at the same time.

Further, in the conventional PDP driving apparatus, during the sustain period, the electric power of the panel capacity Cp is recovered by a resonance circuit composed of recovery switch elements Q9Y and Q10Y, recovery diodes D1 and D2, a recovery inductor CY, and a recovery capacitor LY. The diodes D1 and D2 block the current flowing into the recovery capacitor when sustain switch elements Q7Y and Q8Y are on, thereby keeping the recovery capacitor CY at a constant voltage (Vs/2).

### DISCLOSURE OF INVENTION

### Problems to be Solved by the Invention

However, since the recovery current flowing by recovery operation is a very large current, it is important to reduce the conduction loss in the recovery diodes in order to save power consumption in the PDP driving apparatus. In particular, the current capacity of recovery diodes must be set large enough. Therefore, a multiplicity of recovery diodes must be connected in parallel, and thus the mounting area of recovery diodes is increased. As a result, it has been difficult to save power consumption and curtail the number of parts at the same time.

The invention is devised to solve the problems, and it is hence an object thereof to present a PDP driving apparatus saved in power consumption and curtailed in the number of parts, without decreasing the voltage of the reset pulse etc. to be applied between electrodes of the PDP.

### Solving Means

In a first aspect of the invention, provided is a PDP driving apparatus for driving a plasma display panel having sustain electrodes, scan electrodes, and address electrodes. The PDP driving apparatus includes a plurality of switch elements. At least one of the plurality of switch elements is a bidirectional switch element. The bidirectional switch element is a device capable of allowing a current to flow through the bidirectional switch element in at least one direction when the bidirectional switch element is on, and preventing a current from flowing through the bidirectional switch element in both directions when the bidirectional switch element is off.

The plurality of switch elements may include a high side switch element, and a low side switch element, those electrically coupled in series. A specific pulse voltage may be applied from a junction point of the high side switch element and the low side switch element to at least one of scan electrodes, sustain electrodes, and address electrodes of the plasma display panel. In this case, at least one of the high side switch element and the low side switch element is a bidirectional switch element.

Alternatively, in the PDP driving apparatus, the plurality of switch elements may include a high side switch element, and a low side switch element, those electrically coupled in series. A specific pulse voltage may be applied from a junction point of the high side switch element and the low side switch element to at least one of scan electrodes, sustain electrodes, and address electrodes of the plasma display panel. A separation switch element may be provided between the junction point and the plasma display panel. The separation switch element is a bidirectional switch element.

Alternatively, the PDP driving apparatus may further include an inductor connected to at least scan electrodes, sustain electrodes, or address electrodes, and a recovery switch element. The recovery switch element is a bidirectional switch and is operable to form, when the recovery switch element is in ON period, a path in which a resonance current due to the inductor and the plasma display panel flows.

The bidirectional switch element may include, for example, at least one of JFET, MESFET, reverse blocking IGBT, and bidirectional lateral MOSFET. The bidirectional switch element may be formed of wide band gap semiconductor. The wide band gap semiconductor has wider band gap than silicon, and contains, for example, at least one of silicon carbide, diamond, gallium nitride, molybdenum oxide and zinc oxide.

In a second aspect of the invention, provided is a PDP driving apparatus for driving a plasma display panel operable to display an image with phosphor emitting a light by the discharge between electrodes, including an electrode driving section that applies a predetermined voltage to the electrodes. The electrode driving section includes a bidirectional switch element.

In a third aspect of the invention, a plasma display including: a plasma display panel operable to display an image with phosphor emitting a light by the discharge between electrodes; and a PDP driving apparatus described above, operable to drive the plasma display panel.

### EFFECTS OF THE INVENTION

The PDP driving apparatus of the invention uses a bidirectional switch element which allows a current to flow in at least one direction when the switch is on and prohibits a current from flowing in bi-direction when the switch is off. Thus the separate switch elements, recovery diodes, or the parts contained in them can be reduced in number, while the scan pulse voltage, reset pulse voltage, and sustain pulse voltage can be applied to the PDP same as in the prior art. As a result, according to the invention, the PDP driving apparatus can be reduced in size. The mounting area is also decreased, and the wiring impedance can be lowered. Further, conduction loss by separate switch elements or recovery diodes in the sustain period is substantially decreased, thereby resulting in a greater power saving.

### BRIEF DESCRIPTION OF DRAWINGS

FIG. 1 is a block diagram of a structure of a plasma display in an embodiment of the invention.

FIG. 2 is an equivalent circuit diagram of a scan electrode driving section and a PDP in embodiment 1 of the invention.

FIG. 3 is a diagram showing an example of configuration of a bidirectional switch which is composed of two reverse blocking IGBTs which are inverse-parallel connected.

FIG. 4 is a diagram showing an applied voltage waveform of a scan electrode of the PDP during a reset period, an address period, and a sustain period, and a diagram showing ON periods of switch elements included in the scan electrode driving section in embodiment 1 of the invention.

FIGS. 5A to 5C are diagrams each showing an example of a sustain switch which is composed of a parallel circuit including a reverse blocking IGBT and a recovery circuit.

FIGS. 6A and 6B are diagrams each showing an example of configuration of a clump circuit.

FIGS. 7A and 7B are diagrams each showing an example of configuration in which a recovery circuit and a clump circuit share some parts.

FIG. 8 is an equivalent circuit diagram of a scan electrode driving section and a PDP in embodiment 2 of the invention.

FIG. 9 is a diagram showing an applied voltage waveform of a scan electrode of the PDP during a reset period, an address period, and a sustain period, and a diagram showing ON periods of switch elements included in the scan electrode driving section in embodiment 2 of the invention.

FIG. 10 is an equivalent circuit diagram of a scan electrode driving section and a PDP in embodiment 3 of the invention.

FIG. 11 is a diagram showing detail configuration of a high side ramp waveform generating section of embodiment 3.

FIG. 12 is a diagram showing an applied voltage waveform of a scan electrode of the PDP during a reset period, an address period, and a sustain period, and a diagram showing ON periods of switch elements included in the scan electrode driving section in embodiment 3 of the invention.

FIG. 13 is an equivalent circuit diagram of a scan electrode driving section and a PDP in embodiment 4 of the invention.

FIG. 14 is a diagram showing an applied voltage waveform of a scan electrode of the PDP during a reset period, an address period, and a sustain period, and a diagram showing ON periods of switch elements included in the scan electrode driving section in embodiment 4 of the invention.

FIG. 15 is a diagram showing an example of configuration of a recover switch which is composed of reverse blocking IGBTs which are inverse-parallel connected.

FIG. 16 is an equivalent circuit diagram of a scan electrode driving section and a PDP in embodiment 5 of the invention.

FIG. 17 is a diagram showing an applied voltage waveform of a scan electrode of the PDP during a reset period, an address period, and a sustain period, and a diagram showing ON periods of switch elements included in the scan electrode driving section in embodiment 5 of the invention.

FIG. 18 is an equivalent circuit diagram of a scan electrode driving section and a PDP in embodiment 6 of the invention.

FIG. 19 is a diagram showing an applied voltage waveform of a scan electrode of the PDP during a reset period, an address period, and a sustain period, and a diagram showing ON periods of switch elements included in the scan electrode driving section in embodiment 6 of the invention.

FIGS. 20A to 20D are diagrams each explaining some examples of a protection circuit for separation switch (for MODE III).

FIGS. 21A to 21D are diagrams each explaining some examples of a protection circuit for separation switch (for MODE VI).

FIG. 22 is an equivalent circuit diagram of a scan electrode driving section and a PDP in a conventional PDP driving apparatus.

### REFERENCE SIGNS

1 Input terminal
10 PDP driving apparatus
11 Scan electrode driving section
12 Sustain electrode driving section
13 Address electrode driving section
20 Plasma display panel
30 Controller
50a-50c Recovery circuit
70, 70a-70d, 71a-71d Protection circuit
112, 2Y, 5Y Reset pulse generating section
113, 3Y, 4Y, 6Y Sustain pulse generating section
1Y Scan pulse generating section
Q1Y High side scan switch element
Q2Y Low side scan switch element
Q7Y High side sustain switch element
Q8Y Low side sustain switch element
QR1, QR3 High side ramp waveform generating section
QR2 Low side ramp waveform generating section
QS1, QS2, QS3 Separation switch
V1, V2, V3 DC voltage source
Vs sustain voltage source

### BEST MODE FOR CARRYING OUT THE INVENTION

Referring now to the drawings, preferred embodiments of the invention are described below.

### Embodiment 1

### 1.1 Configuration

### 1.1.1 Plasma Display

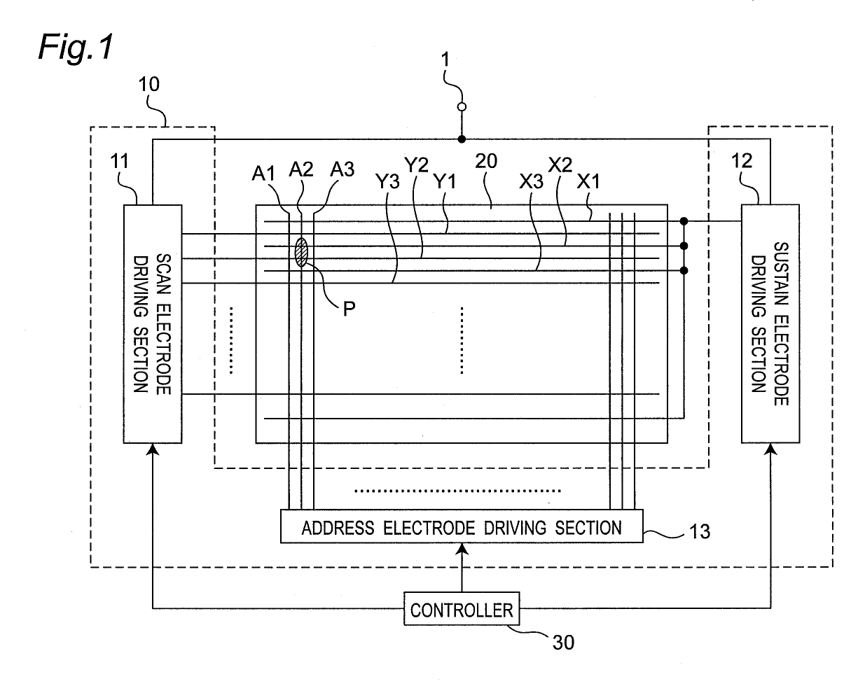

FIG. 1 is a block diagram showing a configuration of a plasma display in an embodiment of the invention. The plasma display includes a PDP driving apparatus 10, a plasma display panel (PDP) 20, and a controller 30.

### (Plasma Display Panel)

The PDP 20 is, for example, of AC type, having three-electrode surface discharge type structure. On a back surface of the PDP 20, address electrodes A1, A2, A3, . . . are disposed along the width direction of the panel. On a front surface of the PDP 20, sustain electrodes X1, X2, X3, . . . and scan electrodes Y1, Y2, Y3, . . . are disposed alternately along the longitudinal direction of the panel. The sustain electrodes X1, X2, X3, . . . are mutually coupled to be substantially equal in the potential. The address electrodes A1, A2, A3, . . . , and scan electrodes Y1, Y2, Y3, . . . can be controlled individually for the potential.

A discharge cell is disposed at an intersection (for example, shaded area P in FIG. 1) of a pair of mutually adjacent sustain electrode and scan electrode (for example, a pair of sustain electrode X2 and scan electrode Y2) and an address electrode (for example, address electrode A2). The surface of the discharge cell includes a layer of dielectric (dielectric layer), a layer for protecting the electrodes and dielectric layer (protective layer), and a layer of phosphor (phosphor layer). The inside of the discharge cell is filled with gas. Application of a specified voltage to the sustain electrode, scan electrode, and address electrode causes discharge in the discharge cell. At this time, gas molecules in the discharge cell are ionized to emit ultraviolet rays. The ultraviolet rays excite the phosphor on the discharge cell surface to generate fluorescence. As a result, the discharge cell emits light.

### (PDP Driving Apparatus)

The PDP driving apparatus 10 includes a scan electrode driving section 11, a sustain electrode driving section 12, and an address electrode driving section 13.

The scan electrode driving section 11 and an input terminal 1 of the sustain electrode driving section 12 are connected to a power supply unit (not shown). The power supply unit first converts an alternating-current voltage from an external commercial power source to a specific direct-current voltage (for example, 400V). The direct-current voltage is further converted into a specified direct-current voltage Vs by a DC-DC converter. The direct-current voltage Vs is applied to the PDP driving apparatus 10. As a result, the potential at the input terminal 1 maintained higher than ground potential (=zero) by direct-current voltage Vs.

Output terminals of the scan electrode driving section 11 are individually connected to scan electrodes Y1, Y2, Y3, . . . of the PDP 20. The scan electrode driving section 11 changes each potential of scan electrodes Y1, Y2, Y3, . . . individually.

Output terminals of the sustain electrode driving section 12 are individually connected to sustain electrodes X1, X2, X3, . . . of the PDP 20. The sustain electrode driving section 12 changes uniformly potentials of sustain electrodes X1, X2, X3, . . . .

The address electrode driving section 13 is connected to address electrodes A1, A2, A3, . . . of the PDP 20 individually. The address electrode driving section 13 generates a signal pulse voltage on the basis of a video signal from outside, and applies it to electrodes selected from address electrodes A1, A2, A3, . . . .

The PDP driving apparatus 10 controls the potential of each electrode of the PDP 20 according to the ADS (Address Display-period Separation) method which is one of sub-field methods. For example, in television broadcast in Japan, one field of image is sent at intervals of 1/60 second (about 16.7 msec). Therefore, the display time per field is constant. In the sub-field method, one field is divided into plural sub-fields. Further, in each sub-field, three periods (reset period, address period, and sustain period) are set commonly in all discharge cells of the PDP 20. Duration of the sustain period differs in each sub-field. In the reset period, address period, and sustain period, different pulse voltages are applied to discharge cells as follows.

In the reset period, a reset pulse voltage is applied between the sustain electrodes X1, X2, X3, . . . and scan electrodes Y1, Y2, Y3, . . . . As a result, the wall charge is made uniform in all discharge cells.

In the address period, the scan electrode driving section 11 applies a scan pulse voltage sequentially to the scan electrodes Y1, Y2, Y3, . . . . Simultaneously with application of the scan pulse voltage, the address electrode driving section 13 applies a signal pulse voltage to the address electrodes A1, A2, A3, . . . . Herein, the address electrodes to be applied with the signal pulse voltage are selected on the basis of a video signal entered from outside. Application of a scan pulse voltage to one scan electrode and a signal pulse voltage to one address electrode causes discharge in the discharge cell positioned at the intersection of such scan electrode and address electrode. This discharge causes a wall charge to be accumulated on the discharge cell surface.

In the sustain period, the scan electrode driving section 11 and sustain electrode driving section 12 alternately apply sustain pulse voltages to scan electrodes Y1, Y2, Y3 . . . or sustain electrodes X1, X2, X3 . . . . At this time, the discharge continues to generate emission at the discharge cells with wall charge accumulated in the address period. Duration of the sustain period varies in each sub-field, and the light emitting time per field of discharge cell, that is, the luminance of discharge cell is adjusted by selection of sub-fields to be emitted.

The scan electrode driving section 11, sustain electrode driving section 12, and address electrode driving section 13 individually incorporate switching inverters inside. The controller 30 controls switching of these driving sections. As a result, the reset pulse voltage, scan pulse voltage, signal pulse voltage, and sustain pulse voltage are generated in specified waveform and at specified timing, individually. The controller 30, in particular, selects address electrodes to be applied with signal pulse voltages based on a video signal from outside. Further, the controller 30 determines the duration of the sustain period after application of the signal pulse voltage, that is, the sub-field to which the signal pulse voltage is to be applied. As a result, each discharge cell emits with appropriate luminance. Thus, the video image corresponding to the video signal is reproduced on the PDP 20.

### 1.1.2 Scan Electrode Driving Section

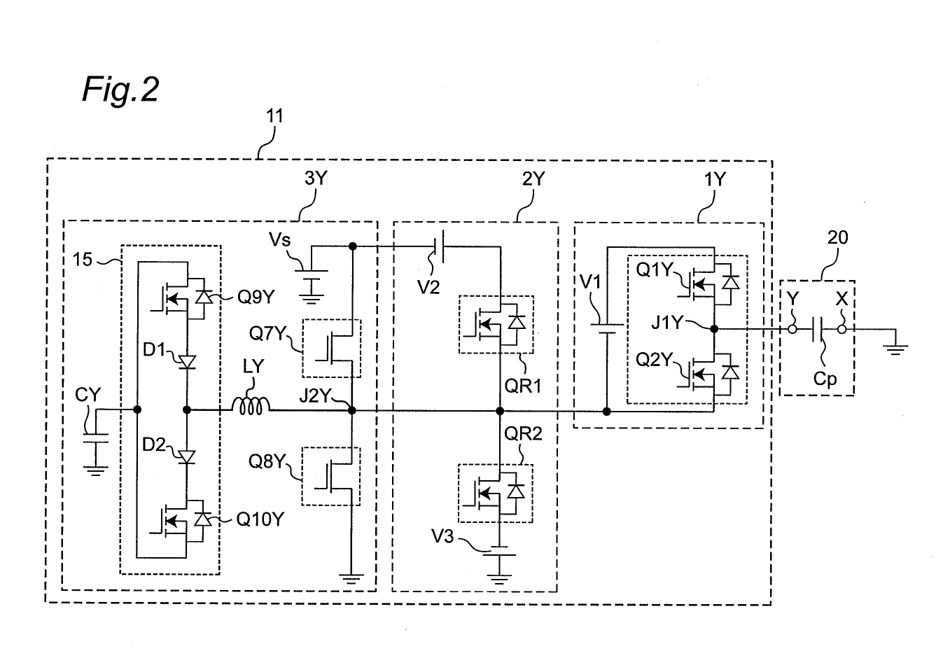

FIG. 2 specifically shows a structure of the scan electrode driving section 11. An equivalent circuit of the PDP 20 is also shown in FIG. 2. The scan electrode driving section 11 includes a scan pulse generating section 1Y, a reset pulse generating section 2Y, and sustain pulse generating section 3Y. The PDP 20 is equivalently expressed by a floating capacity Cp (PDP panel capacity) between the sustain electrode X and scan electrode Y. A path of a current flowing in the PDP 20 on discharge at the discharge cell is not shown. In FIG. 2, the sustain electrode driving section connected to the sustain electrode X is omitted, and the sustain electrode X is shown in grounded state in the diagram.

### (Scan Pulse Generating Section)

The scan pulse generating section 1Y includes a first constant voltage source V1, a high side scan switch element Q1Y, and low side scan switch element Q2Y.

The first constant voltage source V1 maintains the positive potential thereof higher than the negative potential by specified voltage V1 on the basis of the direct-current voltage Vs applied from the power supply unit, using, for example, a DC-DC converter (not shown).

The two scan switch elements Q1Y and Q2Y are, for example, MOS FETs. They may be also IGBTs or bipolar transistors.

The positive electrode of the first constant voltage source V1 is connected to the drain of the high side scan switch element Q1Y. The source of the high side scan switch element Q1Y is connected to the drain of the low side scan switch element Q2Y. The junction J1Y of them is connected to one scanning electrode Y of the PDP 20. The source of the low side scan switch element Q2Y is connected to the negative electrode of the first constant voltage source V1.

Herein, the series connection circuits (portion enclosed by solid line in FIG. 2) of the high side scan switch element Q1Y and low side scan switch element Q2Y are actually provided as many as the number of scan electrodes Y1, Y2, . . . , and are individually connected to the scan electrodes Y1, Y2, . . . .

### (Reset Pulse Generating Section)

The reset pulse generating section 2Y includes a second constant voltage source V2, a high side ramp waveform generating section QR1, a low side ramp waveform generating section QR2, and a third constant voltage source V3.

The second constant voltage source V2 maintains a potential of the positive electrode higher than the direct-current voltage Vs applied, for example, from the power supply unit by the DC-DC converter, by specified voltage V2.

The third constant voltage source V3 maintains a potential of the positive electrode higher than a potential of the negative electrode by specified voltage V3 on the basis of direct-current voltage Vs applied from the power supply unit, using, for example, a DC-DC converter.

The ramp waveform generating sections QR1 and QR2 include, for example, N-channel MOS FET (NMOS). The gate and drain of the NMOS are connected via a capacitor. When the ramp waveform generating sections QR1 and QR2 are turned on, the voltage between the drain and source changes to zero substantially at constant speed.

The positive electrode of the second constant voltage source V2 is connected to the drain of the high side ramp waveform generating section QR1. The source of the high side ramp waveform generating section QR1 is connected to the negative electrode of the first constant voltage source V1. The negative electrode of the second constant voltage source V2 is connected to the positive electrode of the sustain voltage source Vs of the sustain pulse generating section 3Y. The drain of the low side ramp waveform generating section QR2 is connected to the negative electrode of the first constant voltage source V1, and the source of the low side ramp waveform generating section QR2 is connected to the negative electrode of the third constant voltage source V3. The positive electrode of the third constant voltage source V3 is grounded.

### (Sustain Pulse Generating Section)

The sustain pulse generating section 3Y includes a series circuit of a high side sustain switch element Q7Y and a low side sustain switch element Q8Y, a recovery inductor LY, a recovery switch 15, and a recovery capacitor CY.

The sustain voltage source Vs maintains a potential of the positive electrode higher than a potential of the negative electrode by specific voltage Vs (sustain voltage). The positive electrode of the sustain voltage source Vs is connected to the drain of the high side sustain switch element Q7Y, and the source of the high side sustain switch element Q7Y is connected to the drain of the low side sustain switch element Q8Y. The source of the low side sustain switch element Q8Y is connected to the negative electrode of the sustain voltage source Vs. The negative electrode of the sustain voltage source Vs is, for example, 0V (grounded state). The junction J2Y between the high side sustain switch element Q7Y and low side sustain switch element Q8Y is connected to the negative electrode of the first constant voltage source V1 as an output terminal of the sustain pulse generating section 3Y. The path from the output terminal J2Y of the sustain pulse generating section 3Y to an anode of the low side scan switch element Q2Y is called “sustain pulse transmission path.”

### (Sustain Switch Element as “BiDirectional Switch Element”)

In the sustain pulse generating section 3Y, in particular, sustain switch elements Q7Y and Q8Y are composed of bidirectional switch elements. In this and the following embodiments, the bidirectional switch element is an element having the following characteristics.

### <Characteristic 1>

during ON period, it allows a current to flow in two directions, from the drain to the source, and from the source to the drain, and can control flow of the current in two directions; and
during OFF period, it prevents a current from flowing in two directions, from the drain to the source, and from the source to the drain. In OFF period, the sufficient absolute maximum rating for drain to source voltage and source to drain voltage is retained (hereinafter, the absolute maximum rating for drain to source voltage or source to drain voltage is referred to as “withstand voltage of bidirectional switch element”).

### <Characteristic 2>

during ON period, it allows a current to flow from the drain to the source, but prevents a current from flowing from the source to the drain; and
during OFF period, it prevents a current from flowing in two directions, from the drain to the source, and from the source to the drain. In OFF period, the sufficient absolute maximum rating for drain to source voltage and source to drain voltage is retained.

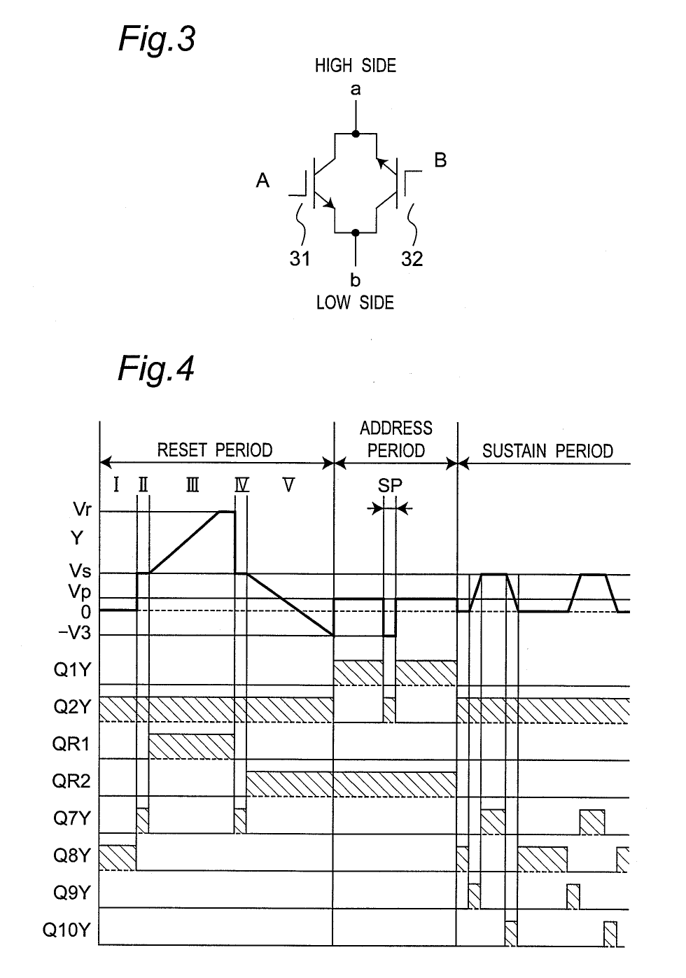

It should be noted that, for example, a reverse blocking IGBT is know as an element having “characteristic 2”. The reverse blocking IGBTs are used for an element having “characteristic 1” when two reverse blocking IGBTs 31 and 32 are connected in inverse-parallel as shown in FIG. 3. Each of reverse blocking IGBTs 31 and 32 includes a plurality of reverse blocking IGBTs connected in parallel.

Examples of such bidirectional switch element include JFET (Junction Field Effect Transistor), and MESFET (Metal Semiconductor Field Effect Transistor). Another example is reverse blocking IGBT (see “1200V class reverse blocking IGBT (RB-IGBT) for AC matrix converter”; by Hideki Takahashi, et al., Proceedings of 2004 International Symposium on Power Semiconductor Devices and ICs, Kitakyushu, pp. 121-124). A bidirectional lateral MOSFET may be also used. The bidirectional lateral MOSFET is MOSFET that shares two drain regions with two MOSFETs and has no drain terminal and two gate terminals (see Akio Sugi et al., “Battery protection IC integrating Bi-directional Trench Lateral Power MOSFETS”, workshop materials of Institute of Electrical Engineers of Japan, EDD-05-53/SPC-05-78, pp. 7-12, Joint Research Society of electronic devices and semiconductor power conversion, Oct. 27-28, 2005, Fukui University). In particular, the bidirectional switch element should have sufficiently high absolute maximum rating for drain to source voltage and source to drain voltage, and thus the withstand voltage of the bidirectional switch element is enhanced. Therefore, a wide band gap semiconductor is effective for suppressing elevation of turn-on resistance Ron. Herein, the wide band gap semiconductor is a semiconductor having a gap wider than silicon (Si). Examples of materials of wide band gap semiconductors include silicon carbide (SiC), diamond, gallium nitride (GaN), molybdenum oxide, zinc oxide (ZnO), and other wide band gap semiconductors. Since the wide band gap semiconductors are small in turn-on resistance, they are advantageous also from the viewpoint of power loss. Otherwise, those having similar characteristics may be also used as bidirectional switch elements.

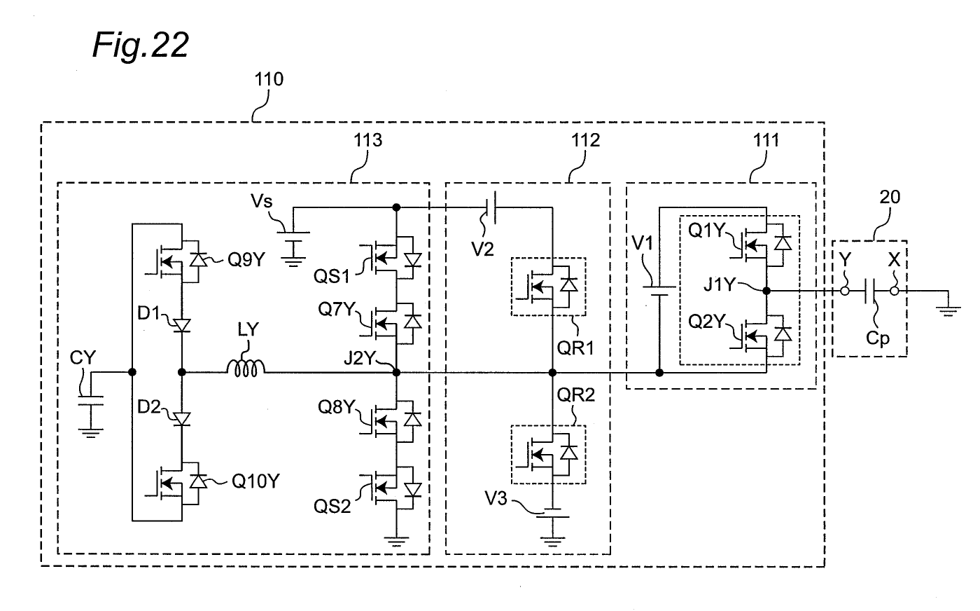

By achieving the sustain switches Q7Y and Q8Y by bidirectional switch elements, reverse conduction can be blocked if a high voltage is applied to the sustain switches Q7Y and Q8Y. Hence, by achieving the sustain switches Q7Y and Q8Y by bidirectional switch elements, in the conventional PDP driving apparatus, it is not required to use separation switch (see FIG. 22) employed in the conventional PDP driving apparatus for blocking reverse conduction in the reset period. Thus the number of parts can be curtailed, and the power loss can be reduced. It is noted that one of the sustain switches Q7Y and Q8Y may be formed of a bidirectional switch element, and the other may be formed of, for example, MOS FET, IGBT, or bipolar transistor. If not using bidirectional switch element, a separation switch element has to be provided to a sustain switch element that is not a bidirectional switch. In this case, the source of sustain switch element (Q7Y or Q8Y) and the source of separation switch element (QS1 or QS2) are connected. Alternatively, the drain of the sustain switch element (Q7Y or Q8Y) and the drain of separation switch element (QS1 or QS2) may be connected. The separation switch element (QS1 or QS2) may be disposed between a positive or negative terminal of the sustain voltage source Vs and the scan electrode. The sustain switch element can be applied to the sustain electrode (sustain electrode driving section 12) and the address electrode (address electrode driving section 13) in addition to the scan electrode (scan electrode driving section 11).

### (Recovery Switch Circuit)

The recovery switch circuit 15 includes a first recovery diode D1, a second recovery diode D2, a high side recovery switch element Q9Y, and a low side recovery switch element Q10Y. The two recovery switch elements Q9Y and Q10Y are, for example, MOSFETs. They may also be IGBTs or bipolar transistors.

The source of the high side recovery switch element Q9Y is connected to an anode of the first recovery diode D1, a cathode of the first recovery diode D1 is connected to an anode of the second recovery diode D2, and a cathode of the second recovery diode D2 is connected to the drain of the low side recovery switch element Q10Y. One end of a recovery inductor LY is connected to a junction J2Y, and the other end is connected to a junction J3Y between the cathode of the first recovery diode D1 and the anode of the second recovery diode D2. One end of the recovery capacitor CY is connected to a negative electrode of the sustain voltage source Vs, and the other end is connected to the drain of the high side recovery switch element Q9Y and the source of the low side recovery switch element Q10Y.

The capacity of the recovery capacitor CY is sufficiently larger than the panel capacity Cp of the PDP 20. The voltage across the recovery capacitor CY is maintained substantially same as a half (Vs/2) of a direct-current voltage Vs applied from the power supply unit.

### 1.2 Operation

FIG. 4 is an applied voltage waveform diagram of the scan electrode Y of the PDP 20 during the reset period, address period, and sustain period, and a diagram showing ON period of each switch element included in the scan electrode driving section 11. In FIG. 4, the ON period of each switch element is indicated in shaded area. The operation in each period is explained below.

### 1.2.1 Reset Period

The reset period is divided into five modes I to V as follows depending on change in reset pulse voltage.

### <Mode I>

In the scan electrode driving section 11, the low side scan switch element Q2Y and low side sustain switch element Q8Y are maintained in ON state. The other switch elements are maintained in OFF state. As a result, the scan electrode Y is maintained at ground potential (=zero).

### <Mode II>

In the scan electrode driving section 11, the low side scan switch element Q2Y and high side sustain switch element Q7Y are maintained in ON state. The other switch elements are maintained in OFF state. As a result, the potential of the scan electrode Y is elevated to a potential higher than ground potential (=zero) by voltage Vs of the sustain voltage source Vs.

### <Mode III>

In the scan electrode driving section 11, while the low side scan switch element Q2Y is maintained in ON state, the high side sustain switch element Q7Y is turned off, and the high side ramp waveform generating section QR1 is turned on. The other switch elements are maintained in OFF state. As a result, the potential of the scan electrode Y is elevated at a specific speed to a potential Vr (hereinafter called “upper limit of the reset pulse voltage”) higher than ground potential (=zero) by sum of a voltage Vs of the sustain voltage source Vs and a voltage V2 of the second constant voltage source.

Thus, the applied voltage is uniformly elevated in all discharge cells of the PDP 20 relatively slowly to the upper limit Vr of the reset pulse voltage. As a result, a uniform wall charge is accumulated in all discharge cells of the PDP 20. At this time, since the elevation speed of the applied voltage is small, luminance of discharge cells is suppressed very low.

### <Mode IV>

In the scan electrode driving section 11, while the low side scan switch element Q2Y is maintained in ON state, the high side ramp waveform generating section QR1 is turned off, and the high side sustain switch element Q7Y is turned on (other switch elements are maintained in OFF state). As a result, the potential of the scan electrode Y descends to a potential higher by voltage Vs of the sustain voltage source Vs with respect to ground potential (=zero).

### <Mode V>

In the scan electrode driving section 11, while the low side scan switch element Q2Y is maintained in ON state, the high side sustain switch element Q7Y is turned off, and the low side ramp waveform generating section QR2 is turned on. The other switch elements are maintained in OFF state. As a result, the potential of the scan electrode Y descends, at a specific speed, to a potential −V3 lower by voltage V3 of the third constant voltage source with respect to ground potential (=zero). Therefore, in the discharge cell of the PDP 20, a voltage with reverse polarity of the applied voltage in modes II to IV is applied. In particular, the applied voltage descends slowly. Hence, the wall charge in all discharge cells is removed equally to be made uniform. At this time, since the descending speed of the applied voltage is small, light emission of the discharge cell is suppressed low.

### 1.2.2 Address Period

During the address period, in the scan electrode driving section 11, the low side ramp waveform generating section QR2 and high side scan switch element Q1Y are maintained in ON state. Therefore, the drain of the high side scan switch element Q1Y is maintained at potential Vp higher than −V3 by voltage V1 of the first constant voltage source (hereinafter called “upper limit of the scan pulse voltage”), and the source of the low side scan switch element Q2Y is maintained at −V3.

Upon start of the address period, in all scan electrodes Y, the high side scan switch element Q1Y is maintained in ON state, and the low side scan switch element Q2Y is maintained in OFF state. As a result, the potential of all scan electrodes Y is uniformly maintained at the upper limit Vp of the scan pulse voltage.

Successively, the scan electrode driving section 11 changes the potential of the scan electrode Y as follows (see the scan pulse voltage SP shown in FIG. 4). When one scan electrode Y is selected, the high side scan switch element Q1Y connected to this scan electrode Y is turned off, and the low side scan switch element Q2Y is turned on. As a result, the potential of this scan electrode Y is lowered to −V3. When the potential of this scan electrode Y is maintained at −V3 for a specified time, the low side scan switch element Q2Y connected to this scan electrode Y is turned off, and the high side scan switch element Q1Y is turned on. Consequently, the potential of the scan electrode Y is elevated up to the upper limit Vp of the scan pulse voltage. The scan electrode driving section 11 sequentially switches similarly and sequentially the scan switch elements Q1Y and Q2Y connected to each of the scan electrodes. Thus, the scan pulse voltage SP is sequentially applied to the scan electrodes.

During the address period, when one address electrode A is selected on the basis of the video signal entered from outside, the potential of the selected address electrode A is elevated to the upper limit Va of the signal pulse voltage for a specified time (not shown).

For example, when the scan pulse voltage SP is applied to one scan electrode Y, and the signal pulse voltage is applied to one address electrode A, a voltage between the scan electrode Y and address electrode A is higher than a voltage between other electrodes. Therefore, discharge occurs in the discharge cell positioned at the intersection of the scan electrode Y and the address electrode A. This discharge causes a new wall charge to be accumulated on the discharge cell surface.

Afterwards, in the sustain period, the scan electrode driving section 11 and sustain electrode driving section 12 (not shown) alternately apply sustain pulse voltages to the scan electrode Y and sustain electrode X (see FIG. 4). At this time, discharge continues in the discharge cell in which the wall charge is accumulated during the address period, and hence light is emitted.

### 1.2.3 Sustain Period

The sustain period is explained below. The low side scan switch element Q2Y is always maintained in ON state.

Immediately before the high side recovery switch element Q9Y is turned on, the low side sustain switch element Q8Y is in ON state, and a voltage across the panel capacity Cp is maintained at 0V. When the high side recovery switch element Q9Y is turned on, an LC resonance circuit is formed by the recovery capacitor CY, high side recovery switch element Q9Y, first recovery diode D1, recovery inductor LY, and panel capacity Cp. As a result, a voltage across the panel capacity Cp is increased up to Vs. The other switch elements are maintained in OFF state.

Then, the high side recovery switch element Q9Y is turned off, and the high side sustain switch element Q7Y is turned on, and a voltage across the panel capacity Cp is maintained at Vs. At this time, a voltage between the drain and source of the high side sustain switch element Q7Y is zero, thus resulting in turn-on with loss of almost zero (the other switch elements are maintained in OFF state).

After a specified time, the high side sustain switch element Q7Y is turned off, and the low side recovery switch element Q10Y is turned on (the other switch elements are maintained in OFF state), and hence an LC resonance circuit is formed by the recovery capacitor CY, low side recovery switch element Q10Y, second recovery diode D2, recovery inductor LY and panel capacity Cp. As a result, the voltage across the panel capacity Cp decreases to 0V.

When the low side recovery switch element Q10Y is turned off and the low side sustain switch element Q8Y is turned on, the voltage across the panel capacity Cp is maintained at 0V. At this time, since the voltage between drain and source of the low side sustain switch element Q8Y is zero, and thus achieving turn-on with loss of almost zero (the other switch elements are maintained in OFF state).

When the potential of the scan electrode Y rises or falls, electric power is efficiently exchanged between the recovery capacitor CY and panel capacity Cp. Thus, when the sustain pulse voltage is applied, reactive power due to charge or discharge of the panel capacity is decreased.

### 1.3 Other Examples

Other examples of the scan electrode driving section of the present embodiment are described below.

### 1.3.1 Example (1) of Applying Reverse Blocking IGBT to Bidirectional Switch Element

An example of applying a reverse blocking IGBT to a bidirectional switch element are described below. When using reverse blocking IGBTs which are inverse-parallel connected with the node a on high side and the node b on low side as shown in FIG. 3, as the bidirectional switch (Q7Y, Q8Y), the number of the parallel-connected reverse blocking IGBTs 32 on the side B may be less than the number of the parallel-connected reverse blocking IGBTs 31 on the side A. A discharge current (a current caused by discharge on the discharge cell in PDP during the sustain period) flows through the reverse blocking IGBTs 31 on the side A. Since the current is large, the number of the parallel-connected reverse blocking IGBTs 31 on the side A is determined so as to allow the current. Only during Mode IV in the reset period, a current flows through the reverse blocking IGBTs on the side B, and the current is small compared to the discharge current. Therefore the number of the parallel-connected reverse blocking IGBTs on the side B may be lesser compared to the parallel-connected reverse blocking IGBTs on the side A.

### 1.3.2 Example (2) of Applying Reverse Blocking IGBT to Bidirectional Switch Element

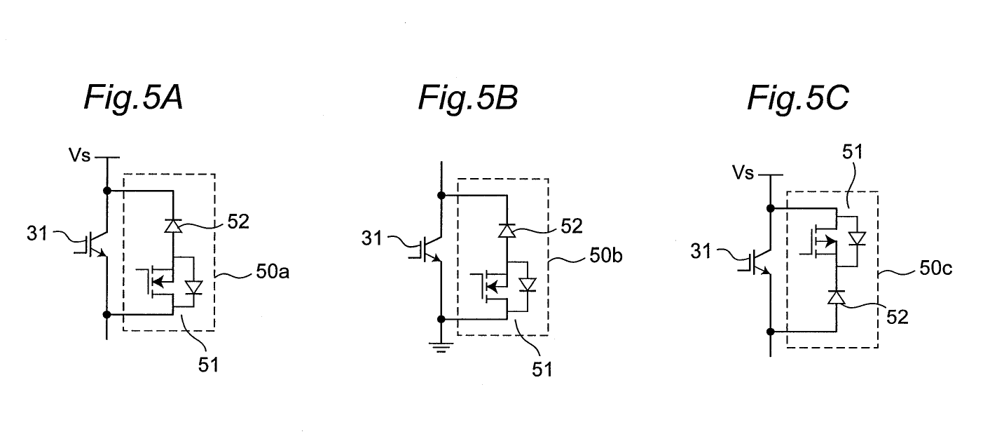

The reverse blocking IGBT 31 which is a bidirectional switch can be applied to the high side sustain switch element Q7Y, and a recovery circuit 50a may be provided for a current flowing from the source to the drain of the reverse blocking IGBT 31 (see FIG. 5A). The recovery circuit 50a includes a recovery switch element 51 and a recovery diode 52. The recovery circuit 50a is a circuit enables a current to flow from the source to the drain of the reverse blocking IGBT 31 when the reverse blocking IGBT 31 is off.

An inverting signal of a control signal for the high side ramp waveform generating section QR1 is fed into the recovery switch element 51. That is, when the high side ramp waveform generating section QR1 is off, the recovery switch element 51 is on.

During mode IV in the reset period, a current flows through the recovery switch element 51 and the recovery diode 52, a potential of the scan electrode Y drops to a potential higher than the ground potential (=zero) by a voltage Vs of the sustain voltage source Vs. The high side sustain switch Q7Y may be kept on during mode III in the reset period (The reverse blocking IGBT can prevent a current from flowing from the node J2y to the positive terminal of the sustain voltage source Vs). Although a voltage for driving the gate of the reverse blocking IGBT on the side B always requires to be higher than the voltage of the sustain voltage source Vs, it is enough that a voltage for driving the gate of the switch element of the recovery circuit is higher than the potential of the node J2Y. This allows the gate driving circuit to be simplified. Since the current flowing the recovery circuit is small, the number of switch elements 31 and diodes 52 in the recovery circuit may be small.

The recovery circuit may have a configuration as shown in FIG. 5C. The recovery circuit 50c shown in FIG. 5C includes a recovery switch 51 which is a P-ch MOS transistor and a recovery diode 52.

It is also possible to adapt a reverse blocking IGBT 31 that functions as a bidirectional switch element to the low side sustain switch element Q8Y and to further attach a regenerative circuit 50b for dealing with the source-to-drain current of the reverse blocking IGBT 31 (see FIG. 5B). The regenerative circuit 50b includes a regenerative switch element 51 and a regenerative diode 52. The regenerative circuit 50b is a circuit capable of making a current flow only in the source-to-drain direction of the reverse blocking IGBT 31 during OFF periods of the reverse blocking IGBT 31. In this case, the regenerative switch element 51 is supplied with an inversion signal of a control signal of the low side ramp waveform generating section QR2. That is, the regenerative switch element 51 is turned off when the low side ramp waveform generating section QR2 is turned on, while the regenerative switch element 51 is turned on when the low side ramp waveform generating section QR2 is off. In shifting to a sustain period after the completion of an address period, a current flows through the regenerative diode 52 and the regenerative switch element 51, so that the potential of the scan electrode Y rises to the ground potential (=0). Note that the low side sustain switch element Q7Y may be in the ON state during the address period (the current from the negative electrode of the sustain voltage source Vs to the junction J2Y can be blocked through the function of the reverse blocking IGBT). Since the current that flows through the regenerative circuit is low, the number of parallel connections of switch elements and diodes may be small in the regenerative circuit.

The prior art as shown in FIG. 22 has a configuration in which the sustain switch elements Q7Y and Q8Y are connected in series with the separation switch elements QS1 and QS2 respectively. Corresponding thereto, the present embodiment has either a configuration in which two reverse blocking IGBTs 31 and 32 are connected in parallel (see FIG. 3) or a configuration in which a reverse blocking IGBT and a regenerative circuit are connected in parallel (see FIG. 5). The number of components in such a configuration will be discussed hereinafter.

While the components are connected in series in the prior art, the components are connected in parallel in the present embodiment. According to the prior art, since large discharge current flows through both the sustain switch elements and the separation switch elements, multiple sustain switch elements and multiple separation switch elements have to be connected in parallel. On the other hand, in the present embodiment, large current flows only through the reverse blocking IGBT 31, and not through the other reverse blocking IGBT 32 and the regenerative circuit 50. Therefore, the number of necessary elements to be connected in parallel can be reduced as a whole.

As apparent from the above, there can be achieved a parallel configuration of the reverse blocking IGBTs in addition to effects such as reduced number of components and reduced loss, by using the characteristic of the reverse blocking IGBT which is capable of preventing a current from flowing in both the drain-to-source direction and the source-to-drain direction during OFF periods and of making a current flow only in the drain-to-source direction during ON periods.

### 1.3.3. Clamping Circuit

Upon turning on the high side sustain switch element Q7Y, a current flows through a loop configured with the sustain voltage source Vs, the high side sustain switch element Q7Y, the recovery inductor LY, the recovery diode D1, the recovery switch element Q9Y, and the recovery capacitor CY so as to charge voltage in parasitic capacitance of the recovery diode D1. Thus, current is stored in the recovery inductor LY, so that a resonance operation is carried out by the parasitic capacitance of the recovery diode D1 and the recovery inductor LY, for a while. For this reason, ringing occurs in the recovery circuit 15, and the recovery circuit 15 becomes a noise source. A clamping circuit may be provided for suppression of the ringing. It should be noted that, since the junction J2Y is applied with the voltage Vs of the sustain voltage source through the high side sustain switch element Q7Y, ringing is not communicated to the scan electrodes.

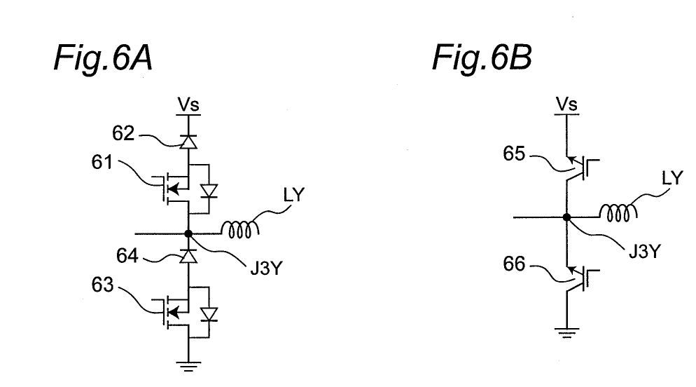

FIG. 6A shows an exemplary configuration of the clamping circuit. The clamping circuit is configured with a series circuit of a clamping switch element 61 and a clamping diode 62, which series circuit is connected between the sustain voltage source Vs and the junction J3Y, and a series circuit of a clamping diode 64 and a clamping switch element 63, which series circuit is connected between the junction J3Y and the ground.

The recovery diode D2 also has parasitic capacitance, and the clamping circuit shown in FIG. 6A has a similar effect over the ringing caused by the recovery diode D2.

### (Operation of Clamping Circuit)

A description is given on the operation of the clamping circuit shown in FIG. 6A. The clamping switch element 61 is in the OFF state in mode III during the reset period. The clamping switch element 61 is in the ON state at all times during the other periods. Therefore, even when the reset pulse voltage is at the voltage Vs of the sustain voltage source or higher (mode III during the reset period), the reset pulse voltage can be applied to the scan electrodes without being clamped.

The clamping switch element 63 is in the OFF state in mode V during the reset period and during the address period. During the other period, the clamping switch element 63 is in the ON state at all times. Therefore, even when the reset pulse voltage is at the ground potential (=0) or lower (mode V during the reset period and during the address period), the reset pulse voltage can be applied to the scan electrodes without being clamped.

During the sustain period, after the high side sustain switch element Q7Y is turned on, a current flows through a loop configured with the positive electrode of the sustain voltage source Vs, the high side sustain switch element Q7Y, the recovery inductor LY, the recovery diode D1, the recovery switch element Q9Y, and the recovery capacitor CY so as to charge voltage in parasitic capacitance of the recovery diode D1.

After a voltage (Vs/2) has been charged in parasitic capacitance of the recovery diode D1, the current stored in the recovery inductor LY flows through the clamping diode 62 and the clamping switch element 61 to the positive electrode of the sustain voltage source Vs, so that the current stored in the recovery inductor is attenuated with resistance components of the clamping diode 62, the clamping switch element 61, and the like. If the amount of current attenuation is small, a resistor may be connected.

As described above, as the current stored in the recovery inductor LY does not flow to the parasitic capacitance of the recovery diode D1, no resonance operation takes place, nor occurs ringing, and thus occurrence of noise can be suppressed.

Similarly, after the low side sustain switch element Q8Y is turned on, a current flows through a loop configured with the negative electrode of the sustain voltage source Vs, the low side sustain switch element Q8Y, the recovery inductor LY, the recovery diode D2, the recovery switch element Q10Y, and the recovery capacitor so as to charge voltage in parasitic capacitance of the recovery diode D2.

After a voltage (Vs/2) has been charged in the parasitic capacitance of the recovery diode D2, the current stored in the recovery inductor LY flows through the clamping diode 64 and the clamping switch element 63 to the negative electrode of the sustain voltage source Vs, so that the current stored in the recovery inductor LY is attenuated by resistance components of the clamping diode 64, the clamping switch element 63, and the like. If the amount of current attenuation is small, a resistor may be connected.

As described above, because the current stored in the recovery inductor LY does not flow to the parasitic capacitance of the recovery diode D2, no resonance operation takes place, or no ringing occurs, and generation of noise can be suppressed.

The clamping circuit may be configured with reverse blocking IGBTs 65 and 66, as shown in FIG. 6B. In such a configuration, although the gate voltage driving circuit for the reverse blocking IGBTs 65 and 66 requires some devisal, the clamping diodes 62 and 64 can be eliminated from the circuit shown in FIG. 6A. The ON-OFF control of the reverse blocking IGBTs is performed similarly as with the clamping switch elements 61 and 63 of FIG. 6A.

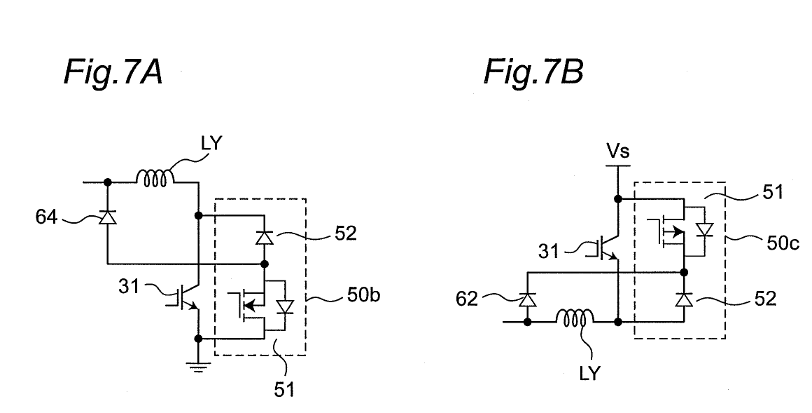

FIGS. 7A and 7B show configurations where the switching elements for the clamping circuit and for the regenerative circuit are shared. By adopting such configurations, the number of switch elements can be reduced. In FIG. 7A, the switch element 51 is shared between the clamping circuit shown in FIG. 6A and the regenerative circuit shown in FIG. 5B. In FIG. 7B, the switch element 51 is shared between the clamping circuit shown in FIG. 6A and the regenerative circuit shown in FIG. 5C.

### 1.4 Summary

According to the PDP driving apparatus 10 of the present embodiment, the sustain switches Q7Y and Q8Y are composed of bidirectional switch elements, and thus can reverse conduction of sustain switches Q7Y and Q8Y in reset period can be blocked. Hence, separation switches (see FIG. 22) used in the conventional PDP driving apparatus are not needed. That is, as shown in FIG. 2, only sustain switches Q7Y and Q8Y are present in the route from the sustain voltage source Vs to the source of low side scan switch element Q2Y by way of output terminal JY2 of sustain pulse generating section 3Y. Hence, according to the embodiment, as compared with the prior art, the number of parts in the PDP driving apparatus is curtailed, and the mounting area is saved. In particular, since a large current flows in separation switch elements in the sustain period, hitherto, it was necessary to connect a multiplicity of separation switch elements in parallel, and the circuit scale can be reduced effectively in the embodiment because separation switch elements are not needed. Besides, the small mounting area decreases wiring impedance by circuit board, and ringing of high frequency component occurring at the time of application of voltage to the PDP, so that the operation margin of the PDP is expanded. Moreover, the conduction loss by separation switch elements in the sustain period is substantially reduced, and the power consumption is saved sufficiently.

In the present embodiment, for the convenience of explanation, in particular, the structure of the scan electrode driving section is described, and the concept of the invention can be similarly applied to the sustain electrode driving section and address electrode driving section (It is true for the following embodiments).

### Embodiment 2

The plasma display of this embodiment differs from embodiment 1 only in the structure of scan electrode driving section 11.

### 2.1 Scan Electrode Driving Section

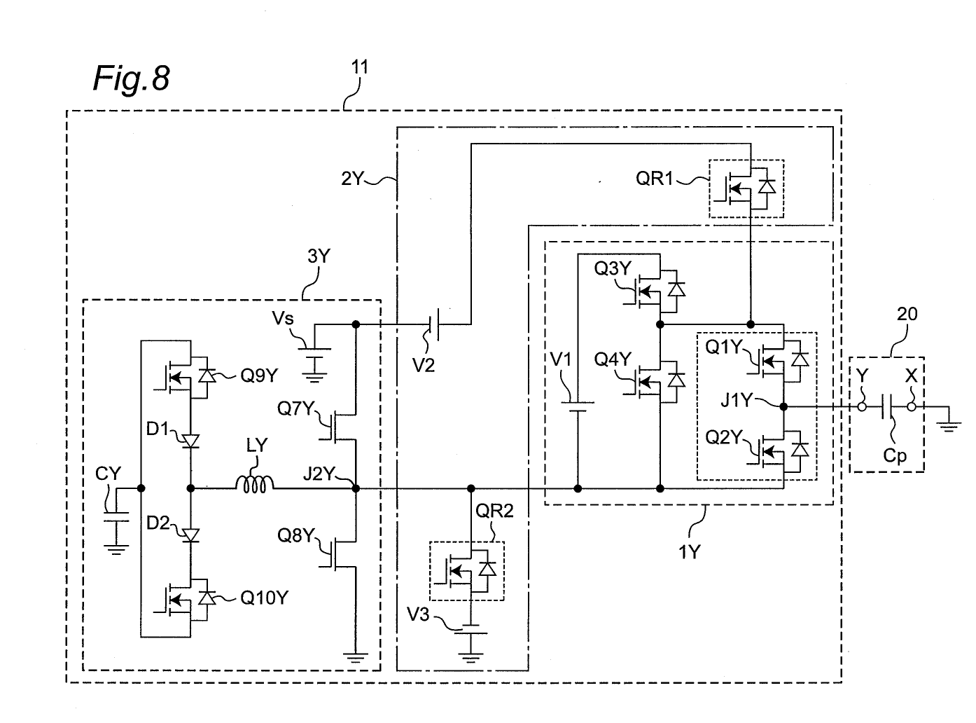

FIG. 8 shows a detailed configuration of the scan electrode driving section 11 of the present embodiment.

The scan electrode driving section 11 according to the present embodiment is different from the one of embodiment 1 shown in FIG. 2 in the configuration of the scan pulse generating section 1Y and the reset pulse generating section 2Y. Other components are the same as those in embodiment 1.

### (Scan Pulse Generating Section)

The scan pulse generating section 1Y includes a first constant voltage source V1, a high side scan switch element Q1Y, a low side scan switch element Q2Y, and V1 applying switch elements Q3Y and Q4Y.

The positive electrode of the first constant voltage source V1 is connected to the drain of the V1 applying switch element Q3Y. The source of the V1 applying switch element Q3Y is connected to the drain of the V1 applying switch element Q4Y and to the drain of the high side scan switch element Q1Y. The source of the V1 applying switch element Q4Y is connected to the source of the low side scan switch element Q2Y and to the negative electrode of the first constant voltage source V1.

In actuality, there are provided as many series circuits, each including a high side scan switch element Q1Y and a low side scan switch element Q2Y (a portion enclosed with a solid line shown in FIG. 2), as the scan electrodes Y1, Y2, . . . , and the series circuits are connected to the scan electrodes Y1, Y2, . . . , one by one.

### (Reset Pulse Generating Section)

The reset pulse generating section 2Y includes a second constant voltage source V2, a high side ramp waveform generating section QR1, a low side ramp waveform generating section QR2, and a third constant voltage source V3.

The positive electrode of the second constant voltage source V2 is connected to the drain of the high side ramp waveform generating section QR1. The source of the high side ramp waveform generating section QR1 is connected to the drain of the high side scan switch element Q1Y. The negative electrode of the second constant voltage source V2 is connected to the positive electrode of the sustain voltage source Vs. The low side ramp waveform generating section QR2 has its drain connected to the negative electrode of the first constant voltage source V1 and its source connected to the negative electrode of the third constant voltage source V3. The positive electrode of the third constant voltage source V3 is grounded.

### 2.2 Operation

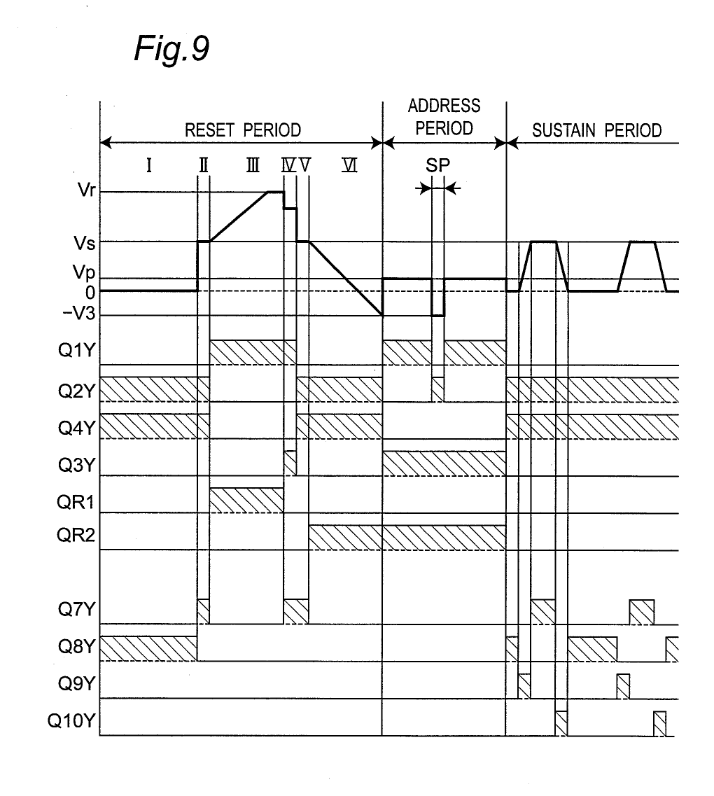

FIG. 9 is a waveform diagram showing a waveform of voltages applied to the scan electrode Y of the PDP 20 alongside ON periods of each switch element included in the scan electrode driving section 11, during a reset period, an address period, and a sustain period, according to the present embodiment. In the figure, the ON period of each switch element is shown as shaded portions. The operations during each period will be described hereinafter.

### 2.2.1 Reset Period

A reset period is divided into the following six modes I to VI according to changes in reset pulse voltage.

### <Mode I>

In the scan electrode driving section 11, the low side scan switch element Q2Y, the V1 applying switch element Q4Y, and the low side sustain switch element Q8Y are maintained in the ON state. The other switch elements are maintained in the OFF state. As a result, the scan electrode Y is kept at the ground potential (=0).

### <Mode II>

In the scan electrode driving section 11, while the low side scan switch element Q2Y and the V1 applying switch element Q4Y are maintained in the ON state, the low side sustain switch element Q8Y is turned off, and the high side sustain switch element Q7Y is turned on. The other switch elements are maintained in the OFF state. As a result, the potential of the scan electrode Y rises to a potential higher than the ground potential (=0) by the voltage Vs of the sustain voltage source Vs.

### <Mode III>

In the scan electrode driving section 11, the low side scan switch element Q2Y, the V1 applying switch element Q4Y, and the high side sustain switch element Q7Y are turned off, and the high side scan switch element Q1Y and the high side ramp waveform generation section QR1 are turned on. The other switch elements are maintained in the OFF state. As a result, the potential of the scan electrode Y rises at a constant speed to a potential Vr (the upper limit of the reset pulse voltage) which is higher than the ground potential (=0) by the sum of the voltage Vs of the sustain voltage source Vs and the voltage V2 of the second constant voltage source. At this point, the V1 applying switch element Q3Y is in the OFF state, and when the drain potential of the high side scan switch element Q1Y reaches a potential higher than the positive electrode potential of the first constant voltage source V1, the parasitic diode of the V1 applying switch element Q3Y is turned on to become conductive. Consequently, the potential of the scan electrode Y reaches the upper limit of the reset pulse voltage, at which point the potential at the junction J2Y attains a maximum level of Vr−V1. Therefore, the voltage applied to the recovery diode D1, across the drain and source terminals of the low side sustain switch element Q8Y, the low side recovery switch element Q10Y, and the low side ramp waveform generating section QR2, and across the source and drain terminals of the high side sustain switch element Q7Y is low as compared with the scan electrode driving section of embodiment 1.

Accordingly, components having low withstand voltages may be used for these elements. Generally, regarding the relationship between the withstand voltage and the resistance per unit area of the silicon semiconductor, the resistance is increased to be higher than five times when the withstand voltage doubles. This means when the withstand voltage is increased, the amount of applicable current drops significantly. Therefore, according to the present embodiment, it is possible to reduce the number of switch elements and diodes connected in parallel in the sustain pulse generating section 3Y, as well as the mounting area for the components, in comparison with the prior art. In particular, since a large current flows through the switch elements Q7Y, Q8Y, and Q10Y, and the diode D1 in the sustain pulse generating section 3Y, reduction in resistance of the switch elements makes it possible to reduce the number of elements to be connected in parallel. Since the mounting area is reduced, wiring impedance due to the circuit board is reduced, so that ringing which is high frequency components that occurs at application of voltage to the PDP is reduced, and thus the operating margin of the PDP is widened.

Thus, the applied voltage rises uniformly to all the discharge cells of the PDP 20 to the upper limit Vr of the reset pulse voltage in a relatively moderate manner, whereby wall charges are accumulated uniformly in all the discharge cells of the PDP 20. At this point, because of the low rising speed of the applied voltage, the light emitted from the discharge cells is suppressed to very low luminance.

### <Mode IV>

In the scan electrode driving section 11, while the high side scan switch element Q1Y is maintained in the ON state, the high side ramp waveform generating section QR1 is turned off, and the high side sustain switch element Q7Y and the V1 applying switch element Q3Y are turned on. The other switch elements are maintained in the OFF state. As a result, the potential of the scan electrode Y falls to a potential (Vs+V1) which is higher than the ground voltage (=0) by the sum of the voltage Vs of the sustain voltage source Vs and the voltage V1 of the first constant voltage source V1.

### <Mode V>

In the scan electrode driving section 11, while the high side sustain switch element Q7Y is maintained in the ON state, the high side scan switch element Q1Y and the V1 applying switch element Q3Y are turned off, and the low side scan switch element Q2Y and the V1 applying switch element Q4Y are turned on. The other switch elements are maintained in the OFF state. As a result, the potential of the scan electrode Y falls to a potential that is higher than the ground potential (=0) by the voltage Vs of the sustain voltage source Vs.

### <Mode VI>

In the scan electrode driving section 11, while the low side scan switch element Q2Y and the V1 applying switch element Q4Y are maintained in the ON state, the high side sustain switch element Q7Y is turned off, and the low side ramp waveform generating section QR2 is turned on. The other switch elements are maintained in the OFF state. The potential of the scan electrode Y falls at a specific speed to a potential −V3 that is lower than the ground potential (=0) by the voltage V3 of the third constant voltage source. Consequently, a voltage of the opposite polarity to the applied voltages in modes II to V is applied to the discharge cells in the PDP 20. Notably, the applied voltage falls in a relatively moderate manner. As a result, wall charges are uniformly removed from all the discharge cells to be equalized. At this point, because of the low falling speed of the applied voltage, the light emitted from the discharge cells is suppressed to very low luminance.

### 2.2.2. Address Period

During the address period, the V1 applying switch element Q3Y is maintained in the ON state, whereas the V1 applying switch element Q4Y is maintained in the OFF state. In the present embodiment, the other switch elements operate in the same manner as described in embodiment 1, during the address period.

### 2.2.3 Sustain Period

During the sustain period, the V1 applying switch element Q3Y is maintained in the OFF state, whereas the V1 applying switch element Q4Y is maintained in the ON state. The other switch elements operate in the same manner as described in embodiment 1, during the sustain period.

In the present embodiment, although the V1 applying switch elements Q3Y and Q4Y need to be provided, switch elements having low withstand voltages may be used. It should be noted that the adaptation of the reverse blocking IGBTs and the configurations of the regenerative circuit and the clamping circuit shown in embodiment 1 may be adapted for use in the present embodiment shown in FIG. 8.

Only one of the sustain switch elements Q7Y and Q8Y may be a bidirectional switch element, and the other may be, e.g., an MOSFET, an IGBT, or a bipolar transistor. In the case where an element other than a bidirectional switch element is used, it is necessary to provide a separation switch element for the sustain switch element which is not a bidirectional switch element. In this case, the source of the sustain switch element (Q7Y or Q8Y) is connected to the source of the separation switch element. Alternatively, the drain of the sustain switch element (Q7Y or Q8Y) may be connected to the drain of the separation switch element. Also, the separation switch element may be disposed between the positive electrode or negative electrode of the sustain voltage source Vs and the scan electrode. The above-described concept on the sustain switch elements can also be applied to an electrode other than a scan electrode (scan electrode driving section 11), that is, to a sustain electrode (sustain electrode driving section 12) or an address electrode (address electrode driving section 13).

### 2.3 Summary

According to the configuration of the present embodiment, although the V1 applying switch elements Q3Y and A4Y need to be used, it becomes possible to use switch elements having low withstand voltages, as compared with embodiment 1.

### Embodiment 3

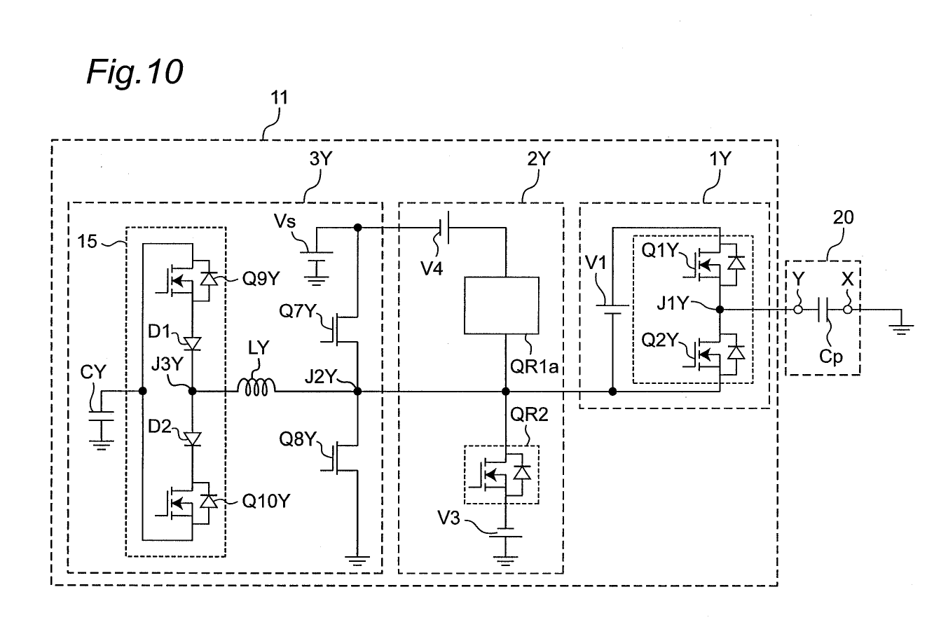

FIG. 10 shows a circuit configuration of a scan electrode driving section according to the present embodiment. A plasma display according to the present embodiment is different from the one of embodiment 1 shown in FIG. 2 in the configuration of the high side ramp waveform generating section in the scan electrode driving section 11. There is also a difference in that a fourth constant voltage source V4 is provided instead of the second constant voltage source V2.

### 3.1. High Side Ramp Waveform Generating Section

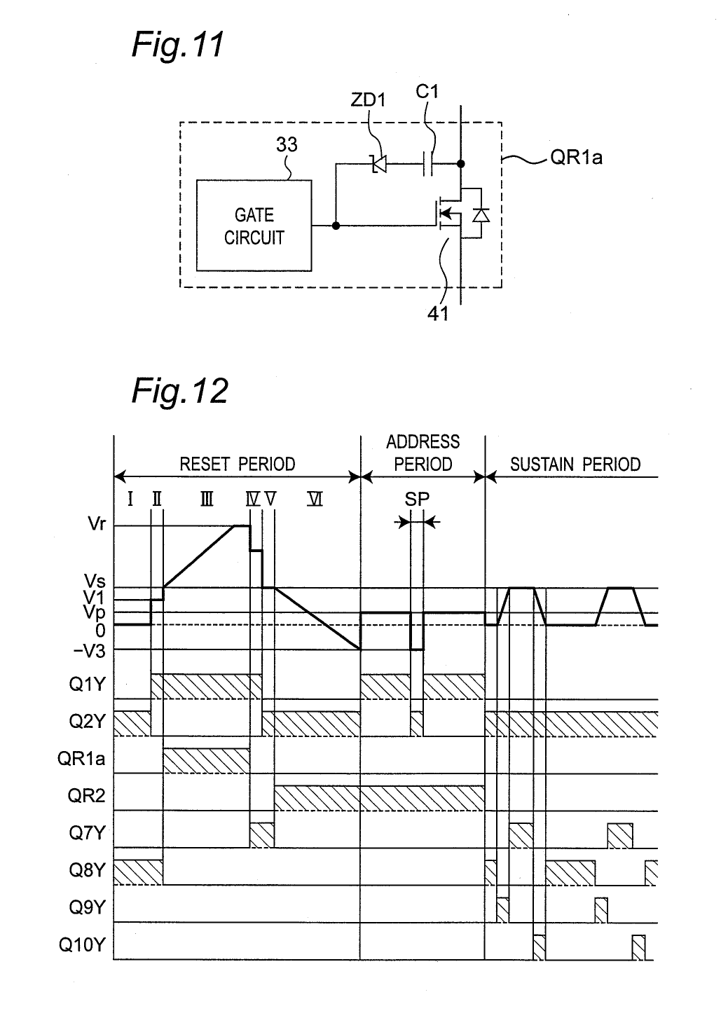

FIG. 11 shows a detailed configuration of a high side ramp waveform generating section QR1a in the scan electrode driving section 11 according to the present embodiment. The high side ramp waveform generating section QR1a shown in the figure includes a high side NMOS (41), a ramp capacitor C1, a ramp Zener diode ZD1, and a gate circuit 33.

The high side NMOS (41) has its drain connected to the positive electrode of the fourth constant voltage source V4 and its source connected to the negative electrode of the first constant voltage source V1. The ramp capacitor C1 has one end connected to the drain of the high side NMOS (41) and the other end connected to the anode of the ramp Zener diode ZD1. The cathode of the ramp Zener diode ZD1 is connected to the gate of the high side NMOS (41). The gate circuit 33 is connected to the gate of the high side NMOS (41), receives a control signal from a controller (not shown), and outputs a specific current based on the control signal.

The specific current outputted from the gate circuit 33 causes a current to flow through the ramp Zener diode ZD1 and to generate a Zener voltage. At this point, charges accumulated in the ramp capacitor C1 is just beginning to be discharged, while the drain-to-gate voltage of the high side NMOS (41) has dropped rapidly due to the Zener voltage. Therefore, even immediately after the reception of the control signal, the source potential of the high side NMOS (41) rises rapidly. The rapid rise is dependent on the Zener voltage of the ramp Zener diode ZD1.

The current from the gate circuit 33 causes the ramp capacitor C1 to discharge at a specific speed, so that the source potential of the high side NMOS (41) rises at a specific speed. Then, the drain-to-gate voltage of the high side NMOS (41) becomes zero and the gate-to-source voltage of the high side NMOS (41) rises, whereby the high side NMOS (Q30Y) becomes approximately equal in potential at its source and drain.

In the above-described manner, any start voltage of the rising ramp waveform (the start voltage of mode III) during the reset period may be set according to the setting of the Zener voltage of the ramp Zener diode ZD1. Also, it is possible to use a high side ramp waveform generator QR1 of embodiment 1 including no Zener diode. In this case, the start voltage of mode III during the reset period is at V1.

### 3.2 Operation

FIG. 12 is a waveform diagram showing a waveform of voltages applied to the scan electrode Y of the PDP 20 alongside ON period of each switch element included in the scan electrode driving section 11, during a reset period, an address period, and a sustain period, according to the present embodiment. In the figure, the ON periods of each switch element are shown as shaded portions. The operations during each period will be described hereinafter.

### 3.2.1. Reset Period

A reset period is divided into the following six modes I to VI according to changes in reset pulse voltage.

### <Mode I>

In the scan electrode driving section 11, the low side scan switch element Q2Y and the low side sustain switch element Q8Y are maintained in the ON state. The other switch elements are maintained in the OFF state. As a result, the scan electrode Y is kept at the ground potential (=0).

### <Mode II>

In the scan electrode driving section 11, while the low side sustain switch element Q8Y is maintained in the ON state, the low side scan switch element Q2Y is turned off, and the high side scan switch element Q1Y is turned on. The other switch elements are maintained in the OFF state. As a result, the potential of the scan electrode Y rises to a potential that is higher than the ground potential (=0) by the voltage V1 of the first constant voltage source.

### <Mode III>

In the scan electrode driving section 11, while the high side scan switch element Q1Y is maintained in the ON state, the low side sustain switch element Q8Y is turned off, and the high side ramp waveform generating section QR1a is turned on. The other switch elements are maintained in the OFF state.

As a result, the potential of the scan electrode Y rises at a specific speed to a potential Vr (=V1+V4) (the upper limit of the reset pulse voltage) with respect to the ground potential (=0). The potential at the junction J2Y attains a maximum level of V4 when the potential of the scan electrode Y reaches the upper limit of the reset pulse voltage. Therefore, the voltage applied to the diode D1, between the drain and source terminals of the switch elements Q8Y, Q10Y, QR1a, QR3, and QR2, and between the source and drain terminals of the switch element Q7Y is low in comparison to the potential (=Vr) at the junction J2Y in the scan electrode driving section of embodiment 1. Accordingly, components having low withstand voltages may be used for these elements. Generally, regarding the relationship between the withstand voltage and the resistance per unit area of the silicon semiconductor is such that the resistance is increased to be higher than five times as the withstand voltage doubles, where the amount of applicable current drops significantly. Thus, according to the present embodiment, it is possible to reduce the number of switch elements and diodes connected in parallel in the sustain pulse generating section 3Y as well as the mounting area for the components, as compared with a conventional apparatus. In particular, since a large current flows through the switch elements Q7Y, Q8Y, and Q10Y, and the diode D1 in the sustain pulse generating section 3Y, the reduced resistance of these components makes it possible to reduce the number of components to be connected in parallel. Hence, a great significance resides in the present invention. Also, as the mounting area becomes small, wiring impedance due to the circuit board decreases, ringing which is high frequency components that occurs at application of voltage to the PDP is reduced, and the operating margin of the PDP is widened.

As such, the applied voltage rises uniformly to all the discharge cells of the PDP 20 to the upper limit Vr of the reset pulse voltage in a relatively moderate manner. Therefore, wall charges are accumulated uniformly in all the discharge cells in the PDP 20. At this point, because of the low rising speed of the applied voltage, the light emitted from the discharge cells is suppressed to very low luminance.

### <Mode IV>

In the scan electrode driving section 11, while the high side scan switch element Q1Y is maintained in the ON state, the high side ramp waveform generating section QR1a is turned off, and the high side sustain switch element Q7Y is turned on. The other switch elements are maintained in the OFF state. As a result, the potential of the scan electrode Y falls to a potential (Vs+V1) with respect to the ground potential (=0).

### <Mode V>

In the scan electrode driving section 11, while the high side sustain switch element Q7Y is maintained in the ON state, the high side scan switch element Q1Y is turned off, and the low side scan switch element Q2Y is turned on. The other switch elements are maintained in the OFF state. As a result, the potential of the scan electrode Y falls to the potential Vs with respect to the ground potential (=0).

### <Mode VI>

In the scan electrode driving section 11, while the low side scan switch element Q2Y is maintained in the ON state, the high side sustain switch element Q7Y is turned off, and the low side ramp waveform generating section QR2 is turned on. The other switch elements are maintained in the OFF state. The potential of the scan electrode Y falls at a specific speed to a potential −V3 with respect to the ground potential (=0). Accordingly, the discharge cells in the PDP 20 are applied with a voltage of the opposite polarity to the applied voltages during modes II to V. Particularly, the applied voltage falls in a relatively moderate manner. As a result, wall charges are uniformly removed from all the discharge cells to be equalized. At this point, because of the low falling speed of the applied voltage, the light emitted from the discharge cells is suppressed to very low luminance.

### 3.2.2. Address Period, Sustain Period

The operations during the address period and the sustain period in the present embodiment is the same as those described in embodiment 1.

It should be noted that the adaptation of the reverse blocking IGBTs and the configurations of the regenerative circuit and the clamping circuit of embodiment 1 may be adapted to the present embodiment. However, the high side sustain switch element Q7Y is not turned on in mode III during the reset period. Also, a protection circuit (a circuit having the same configuration of the circuit for mode III during the reset period of embodiment 6 but the removed diode D5), which will be described later, may be adapted to the switch element of the regenerative circuit and the switch element of the clamping circuit, thereby making it possible to use switch elements having low withstand voltages.

Only one of the sustain switch elements Q7Y and Q8Y may be a bidirectional switch element, and the other may be, e.g., an MOSFET, an IGBT, or a bipolar transistor. In the case where a bidirectional switch element is not used, the sustain switch element which is not a bidirectional switch element needs to be provided with a separation switch element (QS1 or QS2) as shown in FIG. 22. In this case, the source of the sustain switch element (Q7Y or Q8Y) is connected to the source of the separation switch element. Alternatively, the drain of the sustain switch element (Q7Y or Q8Y) may be connected to the drain of the separation switch element. Also, the separation switch element may be disposed between the positive electrode or negative electrode of the sustain voltage source Vs and the scan electrode. The sustain switch element can also be applied to an electrode other than a scan electrode (scan electrode driving section 11), that is, a sustain electrode (sustain electrode driving section 12) or an address electrode (address electrode driving section 13).

### 3.3 Summary

According to the configuration of the present embodiment, it is possible to provide a further advantage that switch elements and diodes having lower withstand voltages can be used, in addition to the effects provided by embodiment 1. In addition, the V1 applying switch elements Q3Y and Q4Y can be eliminated from the configuration of embodiment 2. Moreover, any start voltage (the start voltage in mode III) of the rising ramp waveform can be set during the reset period.

### Embodiment 4

The plasma display of this embodiment differs from embodiment 1 only in the structure of scan electrode driving section 11.

### 4.1 Scan Electrode Driving Section

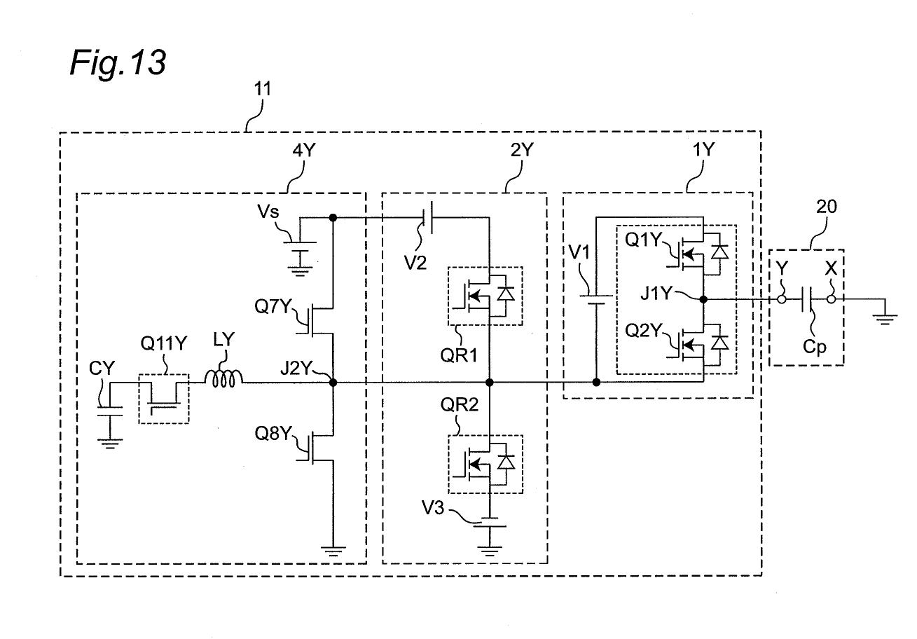

FIG. 13 shows the scan electrode driving section in embodiment 4 of the invention.

The scan electrode driving section 11 of the embodiment differs from embodiment 1 shown in FIG. 2 in the structure of the sustain pulse generating section. More specifically, the recovery switch circuit in the sustain pulse generating section is different. The other components are same as those in embodiment 1.

The sustain pulse generating section 4Y of the present embodiment is provided with a recovery switch element Q11Y instead of the recovery switch circuit 15 in the sustain pulse generating section 3Y in embodiment 1. This recovery switch element Q11Y is formed of a bidirectional switch element. The bidirectional switch element is explained in embodiment 1.

Thus, replacement of the recovery switch circuit 15 in embodiment 1 by the bidirectional switch element Q11Y causes the number of parts to be curtailed and the circuit scale to be reduced.

The recovery switch element Q11Y has its source connected to one end of the recovery inductor LY, and its drain connected to one end of the recovery capacitor CY. The other end of the recovery inductor LY is connected to the junction J2Y of sustain switches Q7Y and Q8Y, and the other end of the recovery capacitor CY is connected to the other end of the recovery capacitor CY of which one end is grounded. The recovery switch element Q11Y may also have its source connected to one end of the recovery capacitor CY, and its drain connected to one end of the recovery inductor LY.

The capacity of the recovery capacitor CY is sufficiently larger than the panel capacity Cp of the PDP 20. The voltage across the recovery capacitor CY is maintained substantially equal to a half (Vs/2) of a direct-current voltage Vs applied from the power supply unit.

In the structure in FIG. 13, the sustain switch elements Q7Y and Q8Y are not limited to be bidirectional switch elements. In such a case, same as in the prior art shown in FIG. 22, separation switch elements QS1 and QS2 must be connected to those other than the sustain switch elements Q7Y and Q8Y. Further the separation switch element (see FIG. 22) may be disposed between a positive or negative terminal of the sustain voltage source Vs and the sustain electrode.

In the recovery switch circuit 15 shown in FIG. 2, either one of a series circuit of the recovery switch element Q9Y and diode D1 and a series circuit of the recovery switch element Q10Y and diode D2 may be replaced by the recovery switch element Q11Y. The recovery switch circuit 15 can be applied not only to the scan electrode (scan electrode driving section 11), but also to the sustain electrode (sustain electrode driving section 12) and address electrode (address electrode driving section 13).

### 4.2 Operation

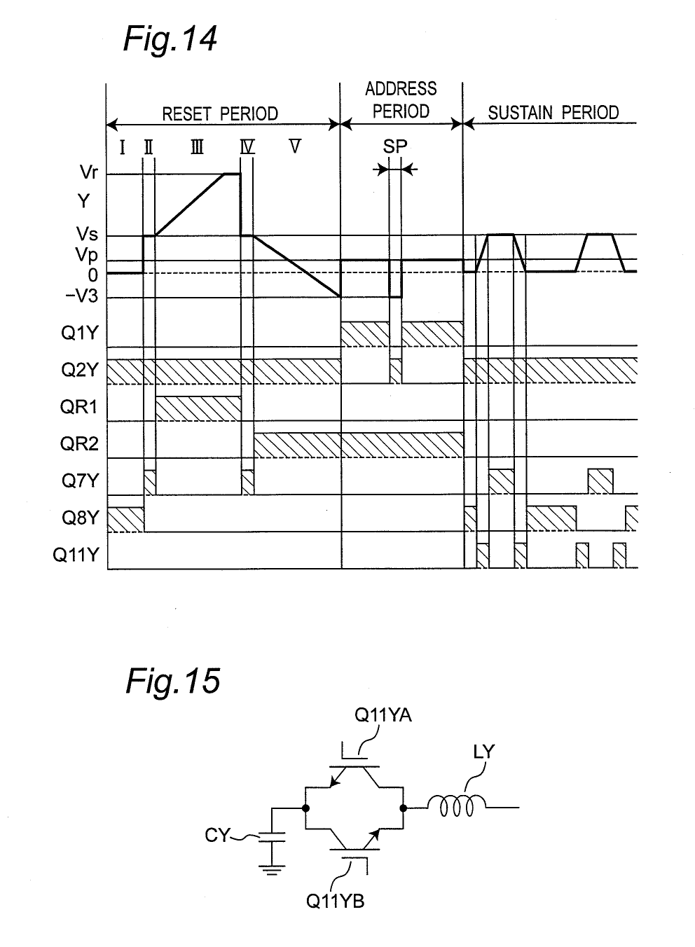

FIG. 14 is an applied voltage waveform diagram of the scan electrode Y of the PDP 20 during a reset period, an address period, and a sustain period, and a diagram showing ON period of each switch element included in the scan electrode driving section 11. In FIG. 14, the ON period of each switch element is indicated in shaded area.

### 4.2.1 Reset Period and Address Period

Operations of switch elements of the scan electrode driving section 11 in the reset period and address period is same as explained in embodiment 1.

### 4.2.2 Sustain Period

Operation in the sustain period is explained by referring to FIG. 13 and FIG. 14.

In the sustain period, the low side scan switch element Q2Y is always maintained in ON state.

Immediately before turning on the recovery switch element Q11Y, the low side sustain switch element Q8Y is ON, and the voltage across the panel capacity Cp is maintained at 0V. When the recovery switch element Q11Y is turned on, an LC resonance circuit is formed by the recovery capacitor CY, recovery switch element Q11Y, recovery inductor LY, and panel capacity Cp, and the across the panel capacity Cp is increased up to Vs (the other switch elements are maintained in OFF state).

Then the recovery switch element Q11Y is turned off, and the high side sustain switch element Q7Y is turned on. This keeps the voltage across the panel capacity Cp at Vs. At this time, since the voltage between the drain and source of the high side sustain switch element Q7Y is zero, it is turned on with loss of almost zero (the other switch elements are maintained in OFF state).

After a specified time, when the high side sustain switch element Q7Y is turned off, and the recovery switch element Q11Y is turned on, an LC resonance circuit is formed by the recovery capacitor CY, recovery switch element Q11Y, recovery inductor LY and panel capacity Cp. As a result, the voltage across the panel capacity Cp decreases to 0V (the other switch elements are maintained in OFF state).

When the recovery switch element Q11Y is turned off and the low side sustain switch element Q8Y is turned on, the voltage across the panel capacity Cp is kept at 0V. At this time, since the voltage between drain and source of the low side sustain switch element Q8Y is zero, it is turned on with a loss of almost zero (the other switch elements are maintained in OFF state).

When the potential of the scan electrode Y rises and falls, the electric power is efficiently exchanged between the recovery capacitor CY and panel capacity Cp. Thus, when the sustain pulse voltage is applied, reactive power due to charge or discharge of the panel capacity is decreased.

### (Example of Reverse Blocking IGBTs Used for Recovery Switch)

If reverse blocking IGBTs are adapted to the recovery switch element Q11Y, it is possible to use reverse blocking IGBTs (Q11YA, Q11YB) connected in parallel as shown in FIG. 15. A description is made hereinafter on the operations during the sustain period in the case of using such reverse blocking IGBTs (Q11YA, Q11YB) connected in parallel.

During the sustain period, the low side scan switch element Q2Y is maintained in the ON state.

Immediately before the recovery switch element Q11YA is turned on, the low side sustain switch element Q8Y is turned on, and the voltage across the panel capacity Cp is kept at 0 V. When the recovery switch element Q11YA is turned on, an LC resonance circuit is formed with the recovery capacitor CY, the recovery switch element Q11YA, the recovery inductor LY, and the panel capacity Cp, and the voltage across the panel capacity Cp is increased to Vs (the other switch elements are maintained in the OFF state).

Next, when the high side sustain switch element Q7Y is turned on, the voltage across the panel capacity Cp is kept at Vs. At this point, although the recovery switch element Q11YA is in the ON state, the reverse blocking IGBT functions to block a current that is applied to charge the recovery capacitor CY. That is, the recovery switch element Q11YA is equivalently in the OFF state. At this point, the high side sustain switch element Q7Y can be turned on almost without loss because its drain-to-source voltage is zero (the other switch elements are maintained in the OFF state).

After the elapse of a predetermined period of time, the high side sustain switch element Q7Y is turned off, the recovery switch element Q11YA is turned off, and the recovery switch element Q11YB is turned on. The recovery capacitor CY, the recovery switch element Q11YB, the recovery inductor LY, and the panel capacity Cp then form an LC resonance circuit, which causes the voltage across the panel capacity Cp to be decreased to zero (the other switch elements are maintained in the OFF state).

Next, the low side sustain switch element Q8Y is turned on, and the voltage across the panel capacity Cp is kept at zero. At this point, although the recovery switch element Q11YB is in the ON state, the reverse blocking IGBT functions to block a current that is applied to discharge the recovery capacitor CY. That is, the recovery switch element Q11YB is equivalently in the OFF state.

At this point, the low side sustain switch element Q8Y can be turned on almost without loss because its drain-to-source voltage is zero (the other switch elements are maintained in the OFF state).

When the potential of the scan electrode Y rises and falls, the power is exchanged efficiently between the recovery capacitor CY and the panel capacity Cp. In this manner, the reactive power generated due to the charge/discharge of the panel capacity is reduced during the application of the sustain pulse voltage.

As described above, the use of the reverse blocking IGBTs enables blocking of the reverse current flow with the inherent characteristics of the reverse blocking IGBTs. Therefore, it becomes possible to keep the recovery switch elements Q11YA and Q11YB in the ON state while having them equivalently in the OFF state against the reverse current flow.

Regarding a general IGBT is turned off, a tail current flows in it for a while, and so it takes some time to completely turn off the IGBT. The tail current herein refers to a current that flows for a while when a switch with a current passing therethrough is forcedly turned off. However, since the reversely flowing current is blocked by the function of the reverse blocking IGBTs, turning off the IGBTs after the complete stop of the current flow prevents a tail current from flowing, so that switching loss of the reverse blocking IGBTs can be reduced. Also, as in the case of adaptation of a bidirectional switch element, the recovery diodes D1 and D2 can be eliminated, and therefore the number of components, as well as the mounting area, can be reduced in comparison with a conventional apparatus. Besides, as the conduction loss due to the recovery diodes D1 and D2 can be cut drastically, power consumption is decreased.

In the case where two reverse blocking IGBTs (Q11YA and Q11YB) are connected in parallel and used as a bidirectional switch element as shown in FIG. 15, although there may be a concern of increase in the number of elements as compared with the case of using one bidirectional switch element, this is no problem. A plurality of bidirectional switch elements are usually used in the state of being connected in parallel in view of heat loss caused by currents. Likewise, each of the reverse blocking IGBTs (Q11YA and Q11YB) is composed of a plurality of reverse blocking IGBTs connected in parallel. While a bidirectional switch element allows a current to flow in two directions, one reverse blocking IGBT only allows a current to flow in a single direction. As such, it is necessary to consider twice as much heat loss as that for a single-directional reverse blocking IGBT (Q11YA or Q11YB) in using a bidirectional switch element, and hence the number of the bidirectional switch elements to be connected in parallel shall be as twice as many as the number of the single-directional reverse blocking IGBTs to be connected in parallel. Consequently, the number of elements will not change even when the configuration as shown in FIG. 15 is used.

### 4.3 Summary

According to the embodiment, as shown in FIG. 13, the recovery switch circuit is formed only by the recovery switch 11 which is a bidirectional switch. That is, there is only recovery switch element Q11Y in a path extending from the recovery capacitor CY to the source of the low side scan switch element Q2Y by way of the inductor LY. Hence, in the PDP driving apparatus 10 of the embodiment, unlike the prior art, the first recovery diode D1 and second recovery diode D2 can be omitted. Hence, according to the PDP driving apparatus 10 of the embodiment, as compared with the prior art, the number of parts is curtailed, and the mounting area is saved.

In particular, since a large current flows in recovery diodes D1 and D2, usually a multiplicity of diodes are connected in parallel. Thus the meaning of eliminating the recovery diodes D1, D2 is significant. Moreover, since the conduction loss by recovery diodes D1 and D2 in the sustain period is substantially reduced, the power consumption is saved sufficiently.

### Embodiment 5

The plasma display of this embodiment differs from embodiment 1 only in the structure of the scan electrode driving section 11.

### 5.1 Scan Electrode Driving Section

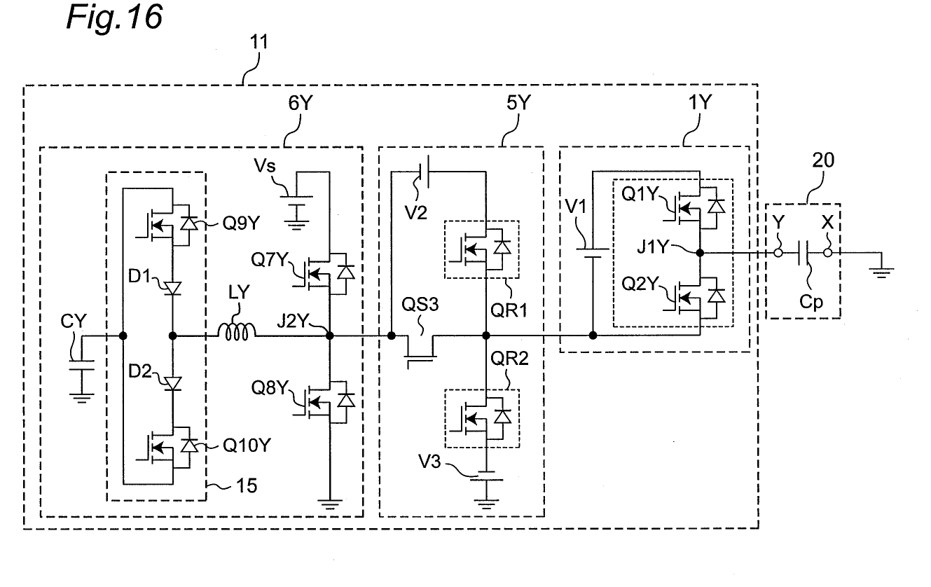

FIG. 16 shows the scan electrode driving section 11 in embodiment 5 of the invention.

The scan electrode driving section 11 of the present embodiment differs from embodiment 1 shown in FIG. 2 in the structure of the reset pulse generating section and sustain pulse generating section. The other components are same as in embodiment 1.

The reset pulse generating section 5Y of the present embodiment has a separation switch element QS3, in addition to the structure of the reset pulse generating section 5Y of embodiment 1. This separation switch element QS3 is formed of a bidirectional switch element. The separation switch element QS3 has its source connected to the negative electrode of the second constant voltage source V2, and its drain connected to the negative electrode of the first constant voltage source V1. In this embodiment, the negative electrode of the second constant voltage source V2 is not connected to the positive electrode of the sustain voltage source Vs, but is connected to the junction JY2. In this respect too, it is different from embodiment 1.

Aside from the structure shown in FIG. 16, the source of the separation switch element QS3 may be connected to the negative electrode of the first constant voltage source V1, and the drain of the separation switch element QS3 may be connected to the negative electrode of the second constant voltage source V2.

The sustain pulse generating section 6Y of the embodiment is similar to embodiment 1, except that the high side sustain switch element Q7Y and low side sustain switch element Q8Y are formed of MOSFET. However, sustain switch elements Q7Y and Q8Y may be formed of IGBT or bipolar transistor, or bidirectional switch element same as in embodiment 1.

In the circuit structure shown in FIG. 16, the recovery switch circuit 15 may be replaced by the recovery switch element Q11Y same as in embodiment 2.

The separation switch element can be applied not only to the scan electrode (scan electrode driving section 11), but also to the sustain electrode (sustain electrode driving section 12) and address electrode (address electrode driving section 13).

### 5.2 Operation

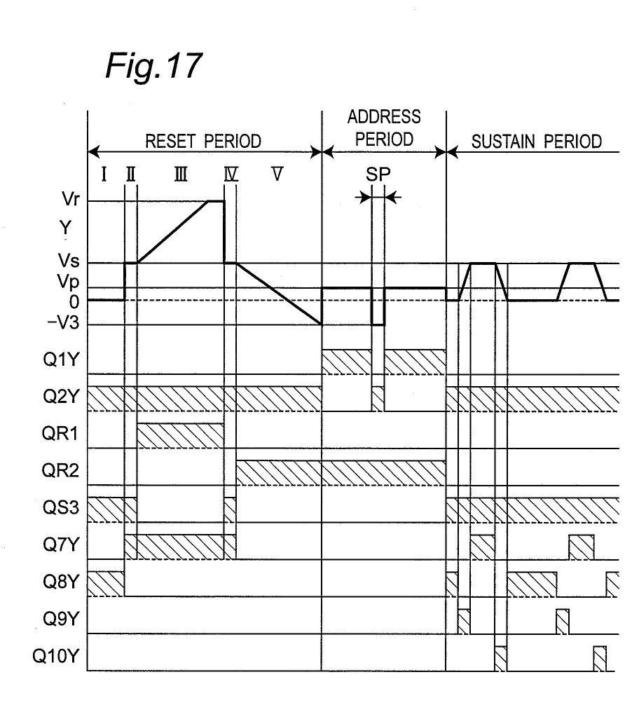

FIG. 17 is an applied voltage waveform diagram of the scan electrode Y of the PDP 20 during a reset period, an address period, and a sustain period, and a diagram showing ON period of each switch element included in the scan electrode driving section 11. In FIG. 17, the ON period of each switch element is indicated in shaded area. Operation in each period is explained below.

### 5.2.1 Reset Period

Operation is classified into five modes I to V as follows depending on change in reset pulse voltage.

### <Mode I>

In the scan electrode driving section 11, the low side scan switch element Q2Y, separation switch element QS3, and low side sustain switch element Q8Y are maintained in ON state. The other switch elements are maintained in OFF state. As a result, the scan electrode Y is maintained at ground potential (=zero).

### <Mode II>

In the scan electrode driving section 11, the low side scan switch element Q2Y, separation switch element QS3, and high side sustain switch element Q7Y are maintained in ON state. The other switch elements are maintained in OFF state. As a result, the potential of the scan electrode Y is elevated to a potential higher than ground potential (=zero) by voltage Vs of the sustain voltage source Vs.

### <Mode III>

In the scan electrode driving section 11, while the low side scan switch element Q2Y and high side sustain switch element Q7Y are maintained in ON state, the separation switch element QS3 is turned off, and the high side ramp waveform generating section QR1 is turned on. As a result, the potential of the scan electrode Y is elevated, at a specific speed, to potential Vr (upper limit of the reset pulse voltage) higher than ground potential (=zero) by the sum of voltage Vs of the sustain voltage source Vs and voltage V2 of the second constant voltage source.

Thus, equally in all discharge cells of the PDP 20, the applied voltage elevates slowly to the upper limit Vr of the reset pulse voltage. At this time, since the elevation speed of the applied voltage is slow, light emission of discharge cells is suppressed low.

### <Mode IV>

In the scan electrode driving section 11, while the low side scan switch element Q2Y and high side sustain switch element Q7Y are maintained in ON state, the high side ramp waveform generating section QR1 is turned off, and the separation switch element QS3 is turned on. The other switch elements are maintained in OFF state. As a result, the potential of the scan electrode Y is lowered to a potential higher than ground potential (=zero) by voltage Vs of the sustain voltage source Vs.

### <Mode V>

In the scan electrode driving section 11, while the low side scan switch element Q2Y is maintained in ON state, the separation switch element QS3 and high side sustain switch element Q7Y are turned off, and the low side ramp waveform generating section QR2 is turned on. The other switch elements are maintained in OFF state. As a result, the potential of the scan electrode Y is lowered to a potential −V3 lower than ground potential (=zero) by voltage V3 of the third constant voltage source. Therefore, discharge cells of the PDP 20 are applied with a voltage in reverse polarity of the voltage applied in modes II to IV. In particular, the applied voltage descends relatively slowly. As a result, wall charge is removed uniformly in all discharge cells, and is equalized. At this time, the descending speed of the applied voltage is slow, and thus light emission of discharge cells is suppressed low.

### 5.2.2 Address Period

Operation in the address period of the present embodiment is same as explained in embodiment 1. During the address period, the separation switch element QS33 is always off.

### 5.2.3 Sustain Period

During the sustain period, the separation switch element QS3 and the low side scan switch element Q2Y are always maintained in ON state.

Operation of other switching elements in the sustain period is same as explained in embodiment 1.

### 5.3 Summary

According to the present embodiment, as shown in FIG. 16, the separation switch element QS3 as bidirectional switch element is provided in a path extending from the output terminal of the sustain pulse generating section 6Y (junction of sustain switch elements Q7Y and Q8Y) JY2 to the source of the low side scan switch element Q2Y. As a result, the potential change range at the output terminal JY2 of the sustain pulse generating section 6Y is controlled from Vs to 0. In the conventional structure shown in FIG. 22, the potential change range at the output terminal JY2 of the sustain pulse generating section 113 ranges from (Vs+V2) to −V3. Thus, according to the present embodiment, as compared with the prior art, the potential change range at the output terminal JY2 of the sustain pulse generating section 6Y becomes narrower. That is, in the present embodiment, parts having lower absolute maximum rating for drain to source voltage and source to drain voltage may be used in switch elements in the sustain pulse generating section 6Y. Generally, in the relation between absolute maximum rating for drain to source voltage and source to drain voltage and resistance of the silicon semiconductor per unit area, the resistance increases 5 times as the absolute maximum rating for drain to source voltage and source to drain voltage increases 2 times. Thus amount of current which can be flowed decreases significantly as the absolute maximum rating for drain to source voltage and source to drain voltage increases. In the embodiment, accordingly, as compared with the prior art, the number of switch elements disposed in parallel in the sustain pulse generating section 6Y can be saved, and the mounting area is decreased. In particular, since a large current flows in switch elements Q7Y, Q8Y, Q9Y and Q10Y of the sustain pulse generating section, decreasing the resistance of each switch element can reduce the number of parts disposed in parallel. Hence the present invention is very significant. Also since the mounting area is smaller, wiring impedance due to the circuit board is smaller, ringing of high frequency component occurring at the time of application of voltage to the PDP is smaller, and the operation margin of the PDP is expanded.

Conventionally, in order not to clamp the scan pulse voltage by the upper limit or lower limit of the sustain voltage source, two types of separation switch elements serially-connected had to be provided at position of a bidirectional switch element. However, in the present embodiment, replacing by bidirectional switch elements as in the present embodiment can reduce two types of separation switch elements serially-connected. As described above, since multiple separation switch elements must be connected in parallel, according to the embodiment not using two types of separation switch elements serially-connected, the circuit scale is reduced effectively. This can saves the mounting area. Wiring impedance due to the circuit board is reduced. Ringing of high frequency component occurring at the time of application of voltage to the PDP is curtailed. Thus the operation margin of the PDP is expanded. Further, conduction loss by separation switch elements in the sustain period is substantially decreased, and the power consumption can be saved sufficiently.

### Embodiment 6

A plasma display according to the present embodiment is different from that of embodiment 1 in the configuration of the scan electrode driving section 11. There is also a difference that a fourth constant voltage source V4 is provided instead of the second constant voltage source V2.

### 6.1. Scan Electrode Driving Section

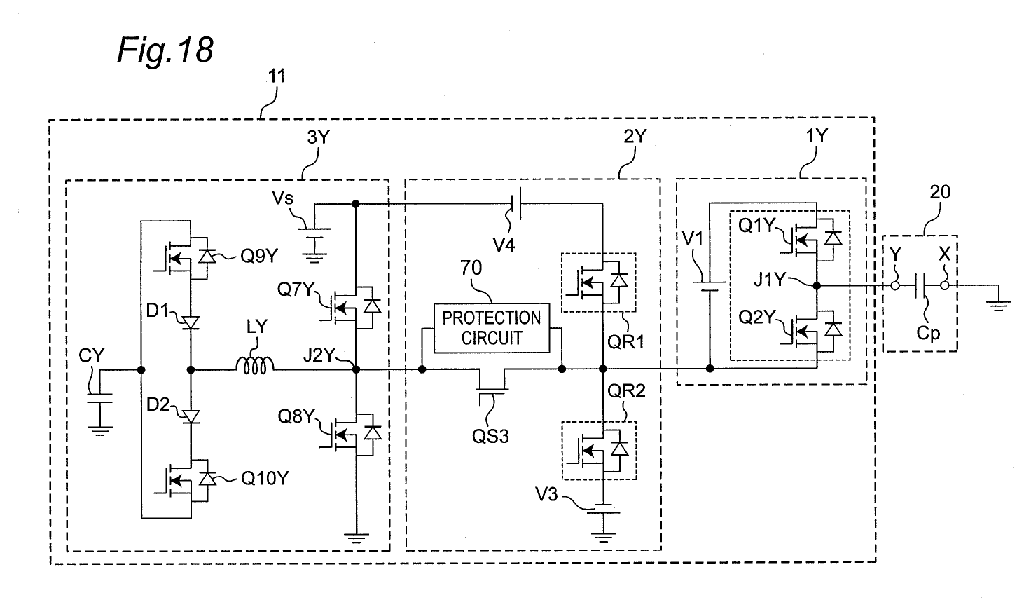

FIG. 18 shows the configuration of the scan electrode driving section 11 according to the present embodiment. The scan electrode driving section 11 according to the present embodiment includes a separation switch element QS3 between a junction of the high side ramp waveform generating section QR1 with the low side ramp waveform generating section QR2 and the junction J2Y. In addition, a protection circuit 70 is connected in parallel with the separation switch element QS3. Details of the protection circuit 70 will be described later. The sustain switch elements Q7Y and Q8Y are bidirectional switch elements. The fourth voltage source V4 is connected between the high side ramp waveform generating section QR1 and the sustain voltage source Vs. The fourth voltage source V4 has its positive electrode connected to the drain of the high side ramp waveform generating section QR1 and its negative electrode connected to the positive electrode of the sustain voltage source Vs. The sustain pulse generating section 3Y of the present embodiment has a configuration similar to that of embodiment 1, but is different therefrom in that the sustain switch elements Q7Y and Q8Y are MOSFETs. However, the sustain switch elements Q7Y and Q8Y may be IGBTs or bipolar transistors, or may be bidirectional switch elements as in embodiment 1.

### 6.2. Operation

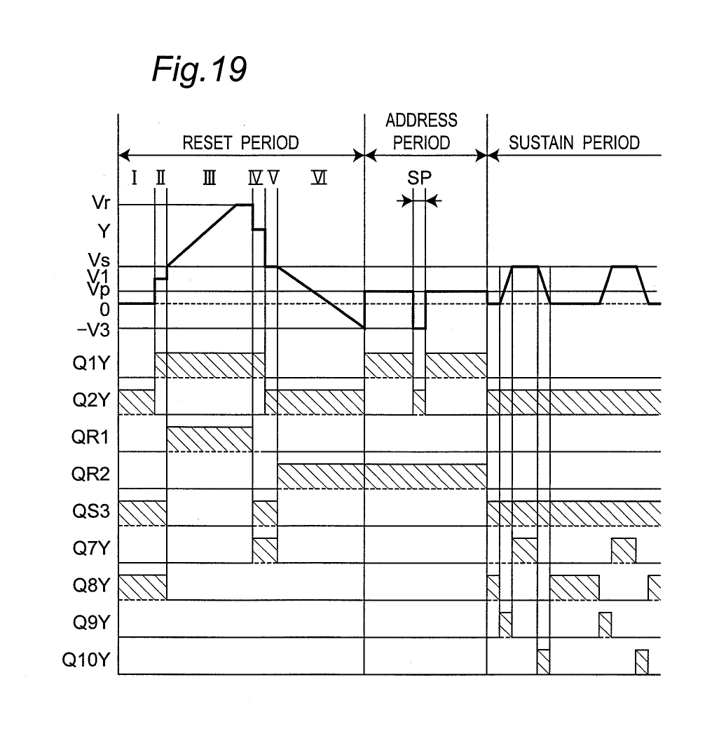

FIG. 19 is a waveform diagram showing a waveform of voltages applied to the scan electrode Y of the PDP 20 alongside ON periods of each switch element included in the scan electrode driving section 11 during a reset period, an address period, and a sustain period, according to the present embodiment. In the figure, the ON periods of the switch elements are shown as shaded portions. The operations during each period will be described below.

### 6.2.1 Reset Period

A reset period is divided into the following six modes I to VI according to changes in reset pulse voltage.

### <Mode I>

In the scan electrode driving section 11, the low side scan switch element Q2Y, the separation switch element QS3, and the low side sustain switch element Q8Y are maintained in the ON state. The other switch elements are maintained in the OFF state. As a result, the scan electrode Y is kept at the ground potential (=0).

### <Mode II>

In the scan electrode driving section 11, while the low side sustain switch element Q8Y and the separation switch element QS3 are maintained in the ON state, the low side scan switch element Q2Y is turned off, and the high side scan switch element Q1Y is turned on. The other switch elements are maintained in the OFF state. As a result, the potential of the scan electrode Y rises to a potential

### <Mode III>

In the scan electrode driving section 11, while the high side scan switch element Q1Y is maintained in the ON state, the low side sustain switch element Q8Y and the separation switch element QS3 are turned off, and the high side ramp waveform generating section QR1 is turned on. The other switch elements are maintained in the OFF state.

As a result, the potential of the scan electrode Y rises to a potential Vr (=V1+V4) (the upper limit of the reset pulse voltage) at a specific speed. When the potential of the scan electrode Y reaches the upper limit of the reset pulse voltage, the potential at the negative electrode of the first constant voltage source V1 attains a maximum level which is V4. Therefore, the voltage to be applied between the drain and source terminals of the switch elements QS3, QR1, and QR2 is low in comparison to the potential (=Vr) of the first constant voltage source V1 in the scan electrode driving section of embodiment 5. Thus, components having low withstand voltages can be used for these elements. Generally, regarding the relationship between the withstand voltage and the resistance per unit area of the silicon semiconductor, the resistance is increased to be higher than five times as the withstand voltage doubles, where the amount of applicable current drops significantly. As such, according to the present embodiment, it is possible to reduce the number of switch elements to be connected in parallel, as well as the mounting area, in the sustain pulse generating section 3Y as compared with a conventional apparatus. In particular, since a large current flows in the separation switch element QS3, decrease in resistance of the separation switch element QS3 leads to the reduced number of elements to be connected in parallel. Thus, the present invention has a great significance in this matter. Also, as the mounting area is reduced, wiring impedance due to the circuit board decreases, ringing which is high frequency components that occurs at application of voltage to the PDP is reduced, and the operating margin of the PDP is widened.

Consequently, the applied voltage to all the discharge cells of the PDP 20 rises uniformly to the upper limit Vr of the reset pulse voltage in a relatively moderate manner. As a result, wall charges are uniformly accumulated in all the discharge cells of the PDP 20. At this point, because of the low rising speed of the applied voltage, the light emitted from the discharge cells is suppressed to very low luminance.

### <Mode IV>

In the scan electrode driving section 11, while the high side scan switch element Q1Y is maintained in the ON state, the high side ramp waveform generating section QR1 is turned off, and the high side sustain switch element Q7Y and the separation switch element QS3 are turned on. The other switch elements are maintained in the OFF state. As a result, the potential of the scan electrode Y falls to a potential (Vs+V1).

### <Mode V>

In the scan electrode driving section 11, while the high side sustain switch element Q7Y and the separation switch element QS3 are maintained in the ON state, the high side scan switch element Q1Y is turned off, and the low side scan switch element Q2Y is turned on. The other switch elements are maintained in the OFF state. As a result, the potential of the scan electrode Y falls to the potential Vs.

### <Mode VI>

In the scan electrode driving section 11, while the low side scan switch element Q2Y is maintained in the ON state, the high side sustain switch element Q7Y and the separation switch element QS3 are turned off, and the low side ramp waveform generating section QR2 is turned on. The other switch elements are maintained in the OFF state. The potential of the scan electrode Y falls at a specific speed to a potential −V3. Accordingly, the discharge cells in the PDP 20 are applied with a voltage of the opposite polarity to the applied voltages in modes II to V. In particular, the applied voltage falls in a relatively moderate manner. As a result, wall charges are uniformly removed from all the discharge cells to be equalized. At this point, because of the low falling speed of the applied voltage, the light emitted from the discharge cells is suppressed to very low luminance.

### 6.2.2 Address Period

The operation during the address period according to the present embodiment is the same as that described in embodiment 1. During the address period, the separation switch element QS3 is in the OFF state at all times.

### 6.3. Protection Circuit

As shown in FIG. 18, the protection circuit 70 and the separation switch element QS3 are connected in parallel so as to limit the drain-to-source voltage or the source-to-drain voltage of the separation switch element QS3. The protection circuit 70 operates in modes III and VI during the reset period.

In mode III during the reset period, the protection circuit 70 starts to operate at the point where the drain-to-source voltage of the separation switch element QS3 exceeds a predetermined value (for example, a value on or below the voltage V4) to raise the potential at the junction J2Y. As a result, the drain-to-source voltage of the separation switch element QS3 is held to be equal to or below the predetermined value. Then, when the potential at the junction J2Y reaches Vs, the parasitic diode of the high side sustain switch element Q7Y is turned on, so that the potential at the junction J2Y does not rise any more. When the potential of the scan electrode Y reaches the upper limit Vr of the reset pulse voltage, the drain-to-source voltage of the separation switch element QS3 becomes V4.

In mode VI during the reset period, the protection circuit 70 starts to operate at the point where the source-to-drain voltage of the separation switch element exceeds a predetermined value (for example, voltage V3) to lower the potential at the junction J2Y. As a result, the source-to-drain voltage of the separation switch element QS3 is held to be equal to or below the predetermined value. Then, when the potential at the junction J2Y reaches the ground potential (=0), the parasitic diode of the low side sustain switch element Q8Y is turned on, so that the potential at the junction J2Y does not fall any more. When the potential of the scan electrode Y reaches −V3, the source-to-drain voltage of the separation switch element QS3 becomes V3.

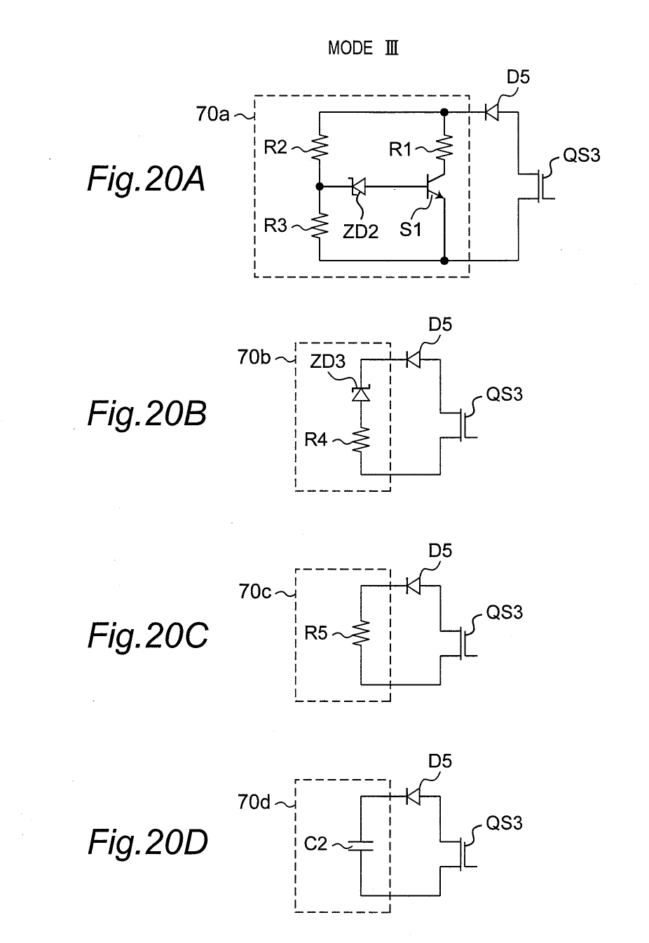

Various exemplary configurations of the protection circuit 70 will be described. FIG. 20 shows various exemplary configurations of the protection circuit capable of performing protective operations in mode III during the reset period.

### 6.3.1. Protection Circuit Using Switch Element

FIG. 20A shows one exemplary configuration of the protection circuit 70. A protection circuit 70a includes a protection switch element S1, a first restricting resistor R1, a gate Zener diode ZD2, and first and second detecting resistors R2 and R3.

The protection switch element S1 has its collector connected to one end of the first restricting resistor R1, its base connected to the anode of the gate Zener diode ZD2, and its emitter to the source of the separation switch element QS3.

The first restricting resistor R1 has the other end connected to the drain of the separation switch element QS3 by way of the diode D5. The first and second detecting resistors R2 and R3 are connected in series, and the junction thereof is connected to the cathode of the gate Zener diode ZD2. The first detecting resistor R2 is connected to the drain of the separation switch element QS3 by way of the diode D5, and the second detecting resistor R3 is connected to the source of the separation switch element QS3.

The protection circuit 70a operates during OFF periods of the separation switch element QS3. As the drain-to-source voltage of the separation switch element QS3 rises, the voltage across the second detecting resistor R3 rises. When the drain-to-source voltage of the separation switch element QS3 reaches a predetermined voltage of Vc, the voltage across the second detecting resistor R3 also reaches a certain voltage value (value dependent on the ratio of the resistance value of the first detecting resistor R2 to that of the second detecting resistor R3). At this point, the Zener voltage of the gate Zener diode ZD2 and the base-to-emitter voltage of the protection switch element S1 become equal to each other, and the protection switch element S1 starts to operate. This protection switch element S1 controls the drain-to-source voltage of the separation switch element QS3 to be constant. The reference voltage value Vc for the constant voltage control needs to be set to be equal to or below the absolute maximum rating for drain-to-source voltage of the separation switch element QS3. For example, if the reference voltage value Vc is set to a value smaller than the voltage V4 of the fourth constant voltage source V4, the source potential of the high side ramp waveform generating section QR1 rises in mode III during the reset period, and when the drain-to-source voltage of the separation switch element QS3 is at Vc, the protection circuit 70a starts to operate.

While the source potential of the high side ramp waveform generating section QR1 is further rising, the protection circuit 70a continues to operate, and thus the source potential of the separation switch element QS3 also continues to rise. The source potential of the high side ramp waveform generating section QR1 rises for a while, and the source potential of the separation switch element QS3 reaches the potential Vs. Then the body diode of the high side sustain switch element Q7Y becomes conductive, and the source of the separation switch element QS3 is clamped at the sustain voltage Vs. At this point, the protection switch element S1 attempts to cause a current to flow in order to achieve constant voltage control. However, the first restricting resistor R1 restricts this operation to prevent the constant voltage control. Thus, although the drain-to-source voltage of the separation switch element QS3 rises with the rise of the source potential of the high side ramp waveform generating section QR1, a maximum value thereof is the voltage value V4, and hence the maximum applicable voltage of the drain-to-source voltage for the separation switch element QS3 is significantly reduced.

As described above, the source potential of the separation switch element QS3 rises with the rise of the source potential of the high side ramp waveform generating section QR3, and the source potential of the separation switch element QS3 reaches the potential Vs before the drain potential of the separation switch element QS3 reaches the potential V4+Vs. Therefore, the absolute maximum rating for the drain-to-source voltage of the separation switch element QS3 will never be exceeded.

### 6.3.2 Protection Circuit Using Zener Diode

FIG. 20B shows another configuration of the protection circuit 70. A protection circuit 70b shown in the figure includes a protective Zener diode ZD3 and a second restricting resistor R4. The protective Zener diode ZD3 has its anode connected to one end of the second restricting resistor R4 and its cathode connected to the drain of the separation switch element QS3 by way of the diode D5, and the second restricting resistor R4 has the other end connected to the source of the separation switch element QS3.

The protection circuit 70b operates during OFF periods of the separation switch element QS3. When the drain-to-source voltage of the separation switch element QS3 rises up to and reaches a Zener voltage Vz, the protective Zener diode ZD3 starts to operate. The protective Zener diode ZD3 controls the drain-to-source voltage of the separation switch element QS3 to be constant. The reference voltage value Vz for the constant voltage control needs to be set to be equal to or below the absolute maximum rating for the drain-to-source voltage of the separation switch element QS3. For example, if the reference voltage value Vz is set to a value smaller than the voltage V4 of the fourth constant voltage source V4, the source potential of the high side ramp waveform generating section QR1 rises in mode III during the reset period, and when the drain-to-source voltage of the separation switch element QS3 is at Vz, the protection circuit 70b starts to operate. While the source potential of the high side ramp waveform generating section QR1 is further rising, the protection circuit 70b continues to operate, so that the source potential of the separation switch element QS3 also continues to rise.

The source potential of the high side ramp waveform generating section QR1 continues rising for a while, and the source potential of the separation switch element QS3 reaches the potential Vs. As a result, the body diode of the high side sustain switch element Q7Y becomes conductive, and the source potential of the separation switch element QS3 is clamped at the voltage Vs of the sustain voltage source. At this point, the constant voltage operation becomes unable to be performed. The protective Zener diode ZD3 is at the constant voltage of Vz, whereas the voltage exceeding therefrom is applied to the second restricting resistor R4, and a current flows toward the source of the separation switch element QS3. Thus, although the drain-to-source voltage of the separation switch element QS3 rises with the rise of the source potential of the high side ramp waveform generating section QR1, a maximum value thereof is the voltage value V4, and hence the maximum applicable voltage of the drain-to-source voltage for the separation switch element QS3 is significantly reduced.

As described above, the source potential of the separation switch element QS3 rises with the rise of the source potential of the high side ramp waveform generating section QR1. The source potential of the separation switch element QS3 is restricted to the potential Vs by the protection circuit 70b before the drain potential of the separation switch element QS3 reaches the potential V4+Vs. Therefore, the drain-to-source voltage of the separation switch element QS1 will never exceed the absolute maximum rating.

### 6.3.3 Protection Circuit Using Resistor

FIG. 20C shows still another configuration of the protection circuit 70. A protection circuit 70c includes a third restricting resistor R5. The third restricting resistor R5 has one end connected to the drain of the separation switch element QS3 by way of the diode D5 and the other end to the source of the separation switch element QS3.

The protection circuit 70c operates during OFF periods of the separation switch element QS3. As the source potential of the high side ramp waveform generating section QR1 rises and the drain-to-source voltage of the separation switch element QS3 rises, a current flows toward the source of the separation switch element QS3 through the third restricting resistor R5, and the source potential of the separation switch element QS3 rises. If the source potential of the high side ramp waveform generating section QR1 further rises, the source potential of the separation switch element QS3 reaches the potential Vs. Then the body diode of the high side sustain switch element Q7Y becomes conductive, so that the source potential of the separation switch element QS3 is clamped at the potential Vs. Thus, although the drain-to-source voltage of the separation switch element QS3 rise with the rise of the source potential of the high side ramp waveform generating section QR1, a maximum voltage value thereof is the voltage value V4, and hence the maximum applicable voltage of the drain-to-source voltage for the separation switch element QS3 is significantly reduced.

As described above, the source potential of the separation switch element QS3 rises with the rise of the source potential of the high side ramp waveform generating section QR1. The source potential of the separation switch element QS3 is restricted to the potential Vs by the protection circuit 70c before the drain potential of the separation switch element QS3 reaches the potential V4+Vs. Therefore, the drain-to-source voltage of the separation switch element QS3 will never exceed the absolute maximum rating.

### 6.3.4 Protection Circuit Using Capacitor

FIG. 20D shows another configuration of the protection circuit 70. A protection circuit 70d includes a protective capacitor C2. The protective capacitor C2 has one end connected to the drain of the separation switch element QS3 by way of the diode D5 and the other end connected to the source of the separation switch element QS3.

The protection circuit 70d operates during OFF periods of the separation switch element QS3. As the source potential of the high side ramp waveform generating section QR1 rises, the source potential of the separation switch element QS3 rises according to capacitance ratio between the capacitance of the protective capacitor C2 and parasitic capacitance present between the source of the separation switch element QS3 and the ground. If the source potential of the high side ramp waveform generating section QR1 further rises, the source potential of the separation switch element QS3 reaches the potential Vs. Then the body diode of the high side sustain switch element Q7Y becomes conductive, so that the source potential of the separation switch element QS3 is clamped at the potential Vs. Thus, although the drain-to-source voltage of the separation switch element QS3 rises with the rise of the source potential of the high side ramp waveform generating section QR1, a maximum value thereof is the voltage value V4, and hence the maximum applicable voltage of the drain-to-source voltage for the separation switch element QS3 is significantly reduced.

As described above, although the source potential of the separation switch element QS3 rises with the rise of the source potential of the high side ramp waveform generating section QR3, the source potential of the separation switch element QS3 is restricted to the sustain voltage Vs by the protection circuit 70d before the drain potential of the separation switch element QS3 reaches the potential V4+Vs. Therefore, it will not exceed the absolute maximum rating for the drain-to-source voltage of the separation switch element QS3.

### 6.3.5 Protection Circuit Adaptable to Mode VI During Reset Period

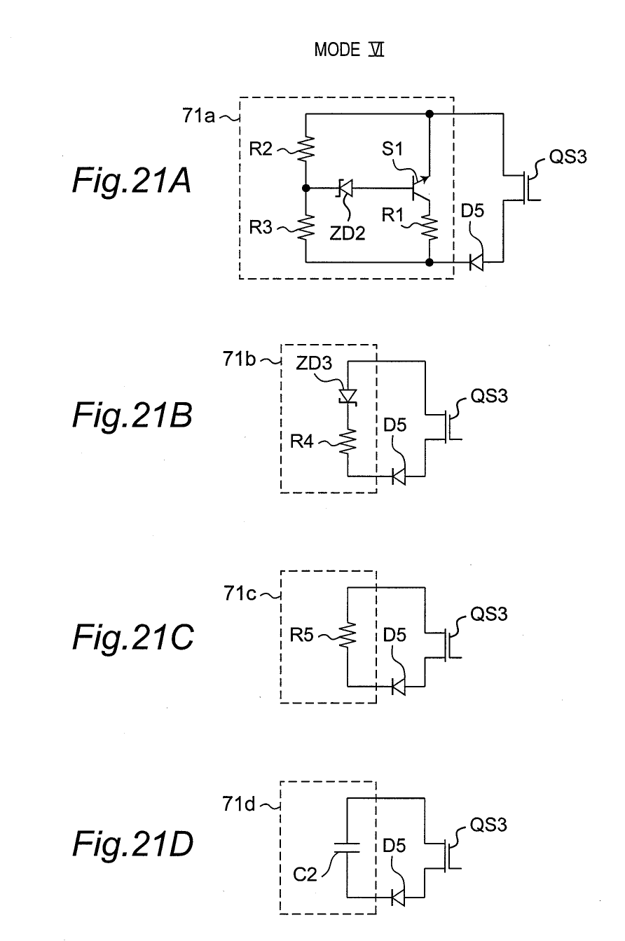

FIG. 21 shows specific exemplary configurations of the protection circuit suitable for protective operations in mode VI during the reset period. Circuits shown in FIGS. 21A to 21D correspond to the circuits shown in FIGS. 20A to 20D and similarly operate, respectively. The protection circuits shown in FIGS. 20C and 20D and FIGS. 21C and 21D need not be provided for each of modes III and VI, and one protection circuit can be shared in both the modes with the diode D5 eliminated.

### 6.4 Summary

According to the present embodiment, the withstand voltage of the separation switch elements can be lowered. With the lowered withstand voltage of the separation switch elements, the resistance of the switch elements can be lowered (when the withstand voltage is halved, the resistance becomes a fifth). Accordingly, the number of separation switch elements to be connected in parallel can be reduced, which leads to reduction in scale of the circuit. Also, the mounting area is decreased in association with the reduction in the number of the separation switch elements, whereby wiring impedance due to the circuit board can be reduced, ringing which is high frequency components that occurs at the application of voltage to the PDP can be reduced, and the operating margin of the PDP is widened. Moreover, since conduction loss due to the separation switch elements during the sustain period is cut drastically, power consumption can be reduced. Besides, sharing of the protection circuit contributes to the reduction in the number of components.

### INDUSTRIAL APPLICABILITY

The invention relates to the PDP driving apparatus, and realizes saving of number of parts, mounting area, and power consumption, by the use of bidirectional switch elements and modification of circuit as described herein. Thus, the industrial applicability of the invention is outstanding.

Having described preferred embodiments of the invention with reference to the accompanying drawings, it is to be understood that the invention is not limited to those precise embodiments, and that various changes and modifications may be effected therein by those skilled in the art without departing from the scope or spirit of the invention as defined in the appended claims.

1. A PDP driving apparatus for driving a plasma display panel having sustain electrodes, scan electrodes, and address electrodes, comprising a plurality of switch elements, wherein
at least one of the plurality of switch elements is a bidirectional switch element, and the bidirectional switch element is a device capable of allowing a current to flow through the bidirectional switch element in at least one direction when the bidirectional switch element is on, and preventing a current from flowing through the bidirectional switch element in both directions when the bidirectional switch element is off.

2. The PDP driving apparatus according to claim 1, wherein
the plurality of switch elements include a high side switch element, and a low side switch element, those electrically coupled in series,
a specific pulse voltage is applied from a junction point of the high side switch element and the low side switch element to at least one of scan electrodes, sustain electrodes, and address electrodes of the plasma display panel, and
at least one of the high side switch element and the low side switch element is a bidirectional switch element.

3. The PDP driving apparatus according to claim 2, further comprising
an inductor connected to the junction point, and
a recovery switch element operable to form, when the recovery switch element is in ON period, a path in which a resonance current due to the inductor and the plasma display panel flows,
wherein the recovery switch element is a bidirectional switch element.

4. The PDP driving apparatus according to claim 1, wherein the bidirectional switch element includes at least one of JFET, MESFET, reverse blocking IGBT, and bidirectional lateral MOSFET.

5. The PDP driving apparatus according to claim 1, wherein the bidirectional switch element is formed of wide band gap semiconductor which has wider band gap than silicon.

6. The PDP driving apparatus according to claim 5, wherein the wide band gap semiconductor contains at least one of silicon carbide, diamond, gallium nitride, molybdenum oxide and zinc oxide.

7. The PDP driving apparatus according to claim 1, further comprising a recovery circuit which is connected to the bidirectional switch element in parallel and includes a series circuit of a diode and a switch element.

8. The PDP driving apparatus according to claim 2, further comprising
an inductor connected to the junction point,
a recovery switch element operable to form, when the recovery switch element is in ON period, a path in which a resonance current due to the inductor and the plasma display panel flows, and
a clamp circuit operable to clamp a potential between the inductor and the recovery switch.

9. The PDP driving apparatus according to claim 8, further comprising a recovery circuit which is connected to the bidirectional switch element in parallel and includes a series circuit of a diode and a switch element,
wherein the clamp circuit includes a diode and the switch element included in the recovery circuit.

10. The PDP driving apparatus according to claim 1, wherein
the plurality of switch elements include a high side switch element, and a low side switch element, those electrically coupled in series,
a specific pulse voltage is applied from a junction point of the high side switch element and the low side switch element to at least one of scan electrodes, sustain electrodes, and address electrodes of the plasma display panel,
a separation switch element is provided between the junction point and the plasma display panel, and
the separation switch element is a bidirectional switch element.

11. The PDP driving apparatus according to claim 10, further comprising:
an inductor connected to the junction point; and
a recovery switch element operable to form, when the recovery switch element is in ON period, a path in which a resonance current due to the inductor and the plasma display panel flows,
wherein the recovery switch element is a bidirectional switch element.

12. The PDP driving apparatus according to claim 10, wherein the bidirectional switch element includes at least one of JFET, MSFET, reverse blocking IGBT, and bidirectional lateral MOSFET.

13. The PDP driving apparatus according to claim 10, wherein the bidirectional switch element is formed of wide band gap semiconductor which has wider band gap than silicon.

14. The PDP driving apparatus according to claim 13, wherein the wide band gap semiconductor contains at least one of silicon carbide, diamond, gallium nitride, molybdenum oxide and zinc oxide.

15. The PDP driving apparatus according to claim 10, wherein the separation switch is connected to a protection circuit in parallel.

16. The PDP driving apparatus according to claim 15, wherein the protection circuit is a constant voltage circuit.

17. The PDP driving apparatus according to claim 15, wherein the protection circuit includes a switch element.

18. The PDP driving apparatus according to claim 15, wherein the protection circuit includes a Zener diode.

19. The PDP driving apparatus according to claim 15, wherein the protection circuit includes a resistor.

20. The PDP driving apparatus according to claim 15, wherein the protection circuit includes a capacitor.

21. The PDP driving apparatus according to claim 1, further comprising:
an inductor electrically connected to at least sustain electrodes, scan electrodes, or address electrodes; and
a recovery switch element operable to form, when the recovery switch element is in ON period, a path in which a resonance current due to the inductor and the plasma display panel flows,
wherein the recovery switch element is a bidirectional switch element.

22. The PDP driving apparatus according to claim 21, wherein the bidirectional switch element includes at least one of JFET, MESFET, reverse blocking IGBT, and bidirectional lateral MOSFET.

23. The PDP driving apparatus according to claim 21, wherein the bidirectional switch element is formed of wide band gap semiconductor which has wider band gap than silicon.

24. The PDP driving apparatus according to claim 23, wherein the wide band gap semiconductor contains at least one of silicon carbide, diamond, gallium nitride, molybdenum oxide and zinc oxide.

25. The PDP driving apparatus according to claim 1, further comprising a high side ramp waveform generating section for generating a rising ramp waveform, wherein a start voltage of the rising ramp waveform of the high side ramp waveform generating section can be arbitrarily adjusted.

26. The PDP driving apparatus according to claim 25, wherein the high side ramp waveform generating section includes a Zener diode.

27. A plasma display comprising:
a plasma display panel having sustain electrodes, scan electrodes, and address electrodes; and
a PDP driving apparatus according to claim 1, operable to drive the plasma display panel.

28. A PDP driving apparatus for driving a plasma display panel operable to display an image with phosphor emitting a light by the discharge between electrodes, comprising an electrode driving section that applies a predetermined voltage to the electrodes, wherein the electrode driving section includes a bidirectional switch element.

29. The PDP driving apparatus according to claim 28, wherein the bidirectional switch element includes at least one of JFET, MESFET, reverse blocking IGBT, and bidirectional lateral MOSFET.

30. The PDP driving apparatus according to claim 28, wherein the bidirectional switch element is formed of wide band gap semiconductor which has wider band gap than silicon.

31. The PDP driving apparatus according to claim 30, wherein the wide band gap semiconductor contains at least one of silicon carbide, diamond, gallium nitride, molybdenum oxide and zinc oxide.

32. A plasma display comprising:
a plasma display panel operable to display an image with phosphor emitting a light by the discharge between electrodes; and
a PDP driving apparatus according to claim 28, operable to drive the plasma display panel.
